(19) United States
(12) Patent Application Publication
(10) Pub. No.: US 2012/0173411 A1
(43) Pub. Date: Jul. 5, 2012

(54) MANAGEMENT METHOD OF ARTICLE

(76) Inventors: Hea Sun Ko, Bucheon-si (KR); Gu Chang Lee, Siheung-si (KR)

(21) Appl. No.: 13/138,028

(22) PCT Filed: Jul. 22, 2009
(86) PCT No.: PCT/KR2009/004070

§ 371 Date: Jul. 18, 2011

(30) Foreign Application Priority Data
Dec. 24, 2008 (KR) 10-2008-0132749

(51) Int. Cl. G06Q 20/10; G06F 21/00

(52) U.S. Cl. 705/39; 726/26

(57) ABSTRACT

An article management method is provided to minimize exposure of personal information, enable traceback in the event of non ownership and allow management and processing by means of setting up/lifting restrictions on an article and/or a terminal only in case of real ownership, thereby preventing additional accidents and having an autonomous management function. The article management method uses a system including: a server that stores not only an intrinsic article code for an article but also an intrinsic terminal code for an article owner's terminal; and a terminal that connects to the server based on the terminal code. The article management method comprises: an ownership registration step of registering the terminal code to the server as a registration terminal code by matching the terminal code with the article code, upon request from the terminal for registration of the article code; a restriction setup step of setting up restrictions on at least one of the article code and the terminal code when preset conditions for the restriction setup are met; a restriction lifting step of lifting the restrictions on at least one of the article code and the terminal code when preset conditions for the restriction lifting are met; and a management and processing step of enabling management and processing depending on whether the restriction is set up for at least one of the article code and the terminal code when preset management and processing are performed for at least one of the article code and the terminal code, upon request from the terminal for management and processing.

### TECHNICAL FIELD

The present invention relates to an article management method, and more particularly, to an article management method, which allows management and processing of an article, like in online or offline transactions, just by managing, in real time, an article code for one's property, such as movable property, real estate, and pets, that is, for an article and a terminal code for an article owner's terminal, such as the phone number of the terminal or the unique number of the terminal, without exposing important personal information such as name, address, and resident registration number.

### BACKGROUND ART

In general, a registration system is established for real estate, which enables an owner to be identified; however, this only involves presuming a person in possession of movable property as the owner and there is no system to clearly identify the owner. Thus there is little chance to collect a lost or stolen article. Therefore, there arises a demand for a means of registering and identifying the owner of an article.

However, personal information leaks are on the rise nowadays, and personal information is becoming a kind of currency. Considering that even crimes involving theft of personal information and details are taking place, there arises a demand for a means of registering and identifying the owner of an article, without providing sensitive personal information of the owner, such as name, address, etc. at the time of ownership registration.

As self-sufficiency is not possible in modern society, above mentioned articles are purchased mostly by commercial transaction. However, with the recent development of a variety of new transaction means, such as e-commerce through online shops or bulletin boards, life information sheets such as flea market sheets, and package delivery systems, it is becoming more and more common to conduct transactions without meeting in person between remote locations or seeing an article concerned in a transaction. Hence, it is easier to sell stolen articles, and this is leading to an increase in the number of thefts and thereby has become a social problem. In other words, these new transaction means are becoming a breeding ground for handling stolen articles; especially, theft cases are becoming rampant.

For example, in the case of bicycles which, people think, are commonly stolen if they are new ones, at least half of the number of used bicycle transactions are assumed to be stolen ones. If someone purchased an article by transaction but the real owner appears and the purchased article is later identified to be a lost article or stolen article, the purchaser may suffer from property loss, like having to give the article to the real owner, and might be mistaken for the criminal unless the purchaser has supporting evidence to back up his or her well-intentioned purchase.

What is worse, people selling stolen articles are specialized criminals or habitual offenders, and they use borrowed-name or stolen-name phones or bank accounts, which makes it difficult to track down suspects. Hence, the purchaser is required to seek ways to verify that the purchased article is not a stolen article or to prove the identity of the seller and the transaction. Moreover, there arises a demand for preventing any further loss or damage in the case of any loss or damage caused by specialized criminals or habitual offenders who sell stolen articles with borrowed-name phones.

A product or article is or may be assigned with an article code, such as a model name to identify the type of the article, a serial number to distinguish it from other articles of the same model, a unique article code, and so on. Although the article code is called in various terms, such as identification code, identification number, serial number, and unique number, it will be hereinafter commonly designated as ‘article code’ in the present invention. For example, a bicycle has an article code, commonly referred to as vehicle identity number, engraved in the bicycle frame.

Such an article code is exclusively given, just like human fingerprint, and enables even articles of the same model or same shape to be distinguished from each other, thereby making it useful to find the owner in case of theft or loss. The article code may be marked on the surface of the article, or printed on a label and affixed thereto, or affixed thereto using an RFID chip, for example, or inserted into the article.

Conventionally, there are methods in which personal information, such as the name, address, phone number, resident registration number, etc. of an owner, is matched with an article code and registered in a database, and in the event of loss or theft, a finder can inquire about the owner by the article code and return it to the owner.

An example of the method to prevent theft of an article and collect the article in the event of loss by registering the article code offline in advance may include the bicycle theft prevention registration system in Japan. This system allows for registration of the vehicle identity number, basic features, and owner information of a bicycle on purchase. To put it plainly, this is almost the same as vehicle registration.

For registration, the owner needs to keep proof of purchase and a receipt and visit a police station. Also, the dealer may handle registration for a small fee. Once registration is completed, registration with the management code printed on it and a sticker will be issued, and the owner needs to stick these on the bicycle.

This sticker will be checked, for example, by questioning. Thus, it can suppress the use and transaction of a lost or stolen bicycle.

However, the police will manage personal information, such as the name, address, phone number, resident registration number, etc. of a bicycle owner, through the registration procedure. Accordingly, there is a problem that the owner has to provide police with his or her personal information, and might be questioned about his or her property by police. Moreover, if the owner of the bicycle changes by sale or in any other manner, the new owner has to get registration from the police.

Based on a concept almost similar to that of the bicycle theft prevention registration system in Japan, disclosed are various methods, which involve using an article code given to an article on the internet to register personal information, such as the contact or the like of the owner for the article code, in a database, and checking for the database to identify the owner of the article and contact the owner. These methods include, especially, Unexamined Korean Patent No. 10-2001-0083647, No. 10-2002-0068708, and No. 10-2008-0028195.

Unexamined Korean Patent No. 10-2001-0083647 titled ‘Article identification and management system using unique number’ discloses a unique number database which associates a unique article number with purchaser's personal information. More specifically, this means that, if the provider has specified a unique article number on a product for sale and the purchaser has provided the provider with personal information on purchase, a finder of this article can provide the unique number of the found article to the provider, and the provider can then inquire about the purchaser's personal information based on the unique article number and contact the purchaser.

Unexamined Korean Patent No. 10-2002-0068708 titled ‘Method and system for managing information on an object with an identifier via a communication network’ involves that, if an administrator has assigned article identifiers (unique numbers) for a plurality of users, and an owner (purchaser) has provided and registered personal information and the identifier of a purchased article to the administrator server, a finder of this article can provide the server with the identifier of the found article, and the server can then contact the owner based on the personal information of the registered identifier.

However, these technologies are merely lost article collecting technologies that store and manage purchaser's personal information corresponding to a unique identifier of an article so that a finder can find the owner, as well as having the problem that sensitive purchaser personal information, such as name, address, resident registration number, etc., has to be provided to the provider or administrator. In other words, these are not methods capable of preventing theft and buying and selling of stolen articles.

Unexamined Patent No. 10-2008-0028195 “Product history management system using serial number” involves that, if an owner has registered a product identification number (unique number) in a product history database, and has updated a product history in advance using status change information in the event of loss or theft, a product status check request can be issued by a used goods shopping mall to provide product status such as loss, theft, etc. so that the used goods shopping mall is banned from selling lost or stolen products.

However, these technologies provide supplementary information about a shopping mall, while having the problem that an owner has to provide his or her personal information, such as name, address, resident registration number, etc. in order to register an identification number. Accordingly, these technologies have no personal information protection function, and do not cover general commercial transactions, but only prevent transaction damage in case that status information, such as loss, theft, etc., is pre-registered and provided. That is, transaction of an article reported stolen can be avoided, while there exists no solution at all for collecting the article once a transaction is made. Moreover, a system of a shopping mall or used goods auction site requires an inquiry module for a product history database, which makes it difficult to actually apply these technologies.

Especially, although the above-mentioned technologies provide means for creating a database of purchasers' personal information to identify an owner, they do not suggest any measure for preventing many damages caused by specialized criminals and habitual offenders anonymously selling stolen articles or fake goods with borrowed-name phones.

### DISCLOSURE

### Technical Problem

The present invention has been made in an effort to solve the above problems occurring in the related art, and to provide an article management method, which can minimize exposure of personal information by registering an article code for an article corresponding to a terminal code for an article owner's terminal in order to fundamentally prevent exposure of sensitive personal information and details, such as name, address, and resident registration number, and damage caused by the exposure.

Furthermore, the present invention provides an article management method, which can set up restrictions on a terminal code, as well as on an article code, in case of problems by continuously verifying the reliability of the terminal code, and which can increase the security of commercial transactions by allowing a seller to register its ownership, checking for any restrictions on the terminal code of the seller and an article concerned before a transaction, and acquiring the terminal code of the seller as a person-in-charge terminal code for the article to enable following-up management.

Furthermore, the present invention provides an article management method, which prevents fake ownership registration by permitting no inquiry as to whether an article code is registered so that the fake owner feels as if he or she walks into a trap, in order to prevent the fake owner from registering a fake ownership after inquiring as to whether the article code is registered.

Furthermore, the present invention provides an article management method, in which a person inquiring about the article code for a lost or stolen article is presumed to be a finder of the article or a person related to the article, and the terminal code of that person is reported to the owner of the article, thereby enabling the collection of the article.

Furthermore, the present invention provides an article management method, which helps to trace back responsibility in the event of non-ownership of stolen articles, fake articles, etc. because the owner of an article can get unconditional registration when making a registration request.

Furthermore, the present invention provides an article management method, which, if multiple ownership registration requests are made for a single article code, an indirect demand for proof of real ownership is raised by setting up restrictions on at least one of the article code and the terminal code, and prevents the accumulation of incidents, such as loss/theft, transactions of stolen goods, fraud transactions, etc. by lifting restrictions on at least one of the article code and the terminal code in the event of real verified ownership, thereby providing an autonomous management function.

### Technical Solution

To achieve the above objects, there is provided an article management method which uses a system including a server that stores not only an intrinsic article code for an article but also an intrinsic terminal code for an article owner's terminal, and a terminal that connects to the server based on the terminal code, the article management method comprising: an ownership registration step of registering the terminal code to the server as a registration terminal code by matching the terminal code with the article code, upon request from the terminal for registration of the article code; a restriction setup step of setting up restrictions on at least one of the article code and the terminal code when preset conditions for the restriction setup are met; a restriction lifting step of lifting the restrictions on at least one of the article code and the terminal code when preset conditions for the restriction lifting are met; and a management and processing step of enabling management and processing depending on whether the restriction is set up for at least one of the article code and the terminal code when preset management and processing are performed for at least one of the article code and the terminal code, upon request from the terminal for management and processing.

Preferably, the ownership registration step is initiated upon an ownership registration request from a person-in-charge terminal, a terminal of the person in charge of the article, the request for ownership registration is a request for issuing ownership registration by matching the article code with the terminal code of the registered terminal, and according to the ownership registration request, the terminal code for the registered terminal is registered to the server as a registered terminal code by matching the terminal code with the article code, and the terminal code of the person-in-charge terminal is also registered to the server as a person-in-charge terminal code.

Preferably, in the ownership registration step, if the terminal code has not been registered, it is determined whether the terminal code is valid, and new terminal code registration is performed on the terminal code in a case that the terminal code is valid.

Preferably, in the ownership registration step, it is determined whether the article code is valid, and if the article code is valid and unregistered, new terminal code registration is performed on the terminal code.

Preferably, in the restriction setup step, if the article code desired to be registered in ownership overlaps a previously registered article code, it is determined whether preset conditions for the restriction setup on the terminal code are met, and if the preset conditions for the restriction setup on the terminal code are met, a terminal code restriction setup is performed on the terminal code registered in ownership.

Preferably, in the restriction setup step, if the article code desired to be registered in ownership overlaps a previously registered article code, an article code restriction setup is performed on the overlapping article code.

Preferably, in the restriction lifting step, if there is no other reason for the restriction on the terminal code associated with the overlapping article code, the following is carried out: (1) If the article code overlap is caused by loss registration or theft registration, terminal code registration lifting is performed on the terminal code for the terminal registered as lost or stolen; (2) If the article code overlap is caused by ownership registration of a false article, terminal code registration lifting is performed on the terminal code for the confirmed terminal, i.e., the terminal proven to be and registered as genuine; and (3) If the article code overlap is caused by multiple ownership registrations only a mistake, terminal code restriction lifting is performed on the terminal codes for all the terminals with registered ownership associated with alternative declaration that only one of the multiple ownership registrations is valid.

Preferably, in the restriction lifting step, if there exists any other reason for the restriction on the terminal code associated with the overlapping article code, and the number of registration setups for the terminal code exceeds a preset reference value, the following is carried out: (1) Terminal code registration lifting is performed on the terminal code for the terminal that has registered credit certification, and (2) Terminal code restriction lifting is performed on the terminal code for the terminal for which it has been proven that the person-in-charge terminal is responsible for the article code overlap, and terminal code restriction setup is performed for the terminal code of the person-in-charge terminal.

Preferably, in the restriction lifting step, (1) If the article code overlap is caused by loss registration or theft registration, terminal code registration lifting is performed when the article registered as lost or stolen is collected; (2) If the article code overlap is caused by ownership registration of a false article, terminal code registration lifting is performed on the terminal code for the confirmed terminal, i.e., the terminal proven to be and registered as genuine; and (3) If the article code overlap is caused by multiple ownership registrations only a mistake, terminal code restriction lifting is performed as far as alternative declaration is made that only one of the multiple ownership registrations is valid.

Preferably, to perform the management and processing step, a transfer registration step is provided in which the article code registered in ownership corresponding to the current registered terminal code is changed to correspond to a new registered terminal code and registered, the transfer registration step comprising: a restriction setup confirmation step in which it is confirmed that no restriction is set up on the article code and no restriction on the terminal code is set up on the current registered terminal code upon a transfer registration request from the current registered terminal that requests to change the article code to an article code for the new registered terminal and register the new article code; a message transmission step in which, if there is no restriction setup, a message indicating that there is no restriction on transfer registration is transmitted to the terminal of the new registered terminal code; a transfer registration execution confirmation step in which a transfer registration execution request is received from the current registered terminal code and the new registered terminal code; and a change registration step in which the new registered terminal code is matched with the article code and registered, and the current registered terminal code, is registered as a person-in-charge terminal code.

Preferably, if the transfer registration is onerous transfer registration, money is deposited after the transfer registration execution confirmation step, and then transferred upon receipt of a money transfer execution request from the current registered terminal code and the new registered terminal code.

Preferably, to perform the management and processing step, a terminal inquiry step is provided in which an inquiry is made as to whether restriction is set up on the terminal code registered in ownership, the terminal inquiry step comprising: a restriction setup confirmation step in which it is checked whether restriction is setup on the registered terminal code upon a terminal inquiry request from the inquiry terminal of the inquirer; and a message transmission step in which, if no restriction is set up on the registered terminal code, a first message is transmitted to the inquiry terminal, and if restriction is setup on the registered terminal code, a second message is transmitted to the inquiry terminal.

Preferably, to perform the management and processing step, an article inquiry step is provided in which an inquiry is made as to whether restriction is set up on the article code registered in ownership, the article inquiry step comprising: a restriction setup confirmation step in which it is checked whether restriction is set up on the article code upon an article inquiry request from the inquiry terminal of the inquirer; a first message transmission step in which, if no restriction is set up on the article code, a first message is transmitted to the inquiry terminal; a registered terminal code input step in which, if there is any restriction on the article code, a registered terminal code corresponding to the article code is input from the inquiry terminal; a second message transmission step in which, if the registered terminal code is a confirmed terminal code recognized as having the restriction lifted from the article code, a second message is transmitted to the inquiry terminal; and a third message transmission step in which; if the registered terminal code is not a confirmed terminal code recognized as having the restriction lifted from the article code, a third message is transmitted to the inquiry terminal.

Preferably, the method of the present invention further comprises an inquiry notification step in which the registered terminal is notified of an article inquiry made by the inquiry terminal.

Preferably, to perform the management and processing step, a loss registration step is provided in which loss or theft of an article corresponding to the article code is handled, the loss registration step comprising: an article restriction setup step in which article code restoration is set up on the article code upon a loss registration request for the article code from the lost terminal of the person who lost it; and an article restriction lifting step in which, when the article is collected by the person who lost it, the article code restriction is lifted.

Preferably, the method of the present invention further comprises a notification step in which, prior to the collection of the article, if the lost article registration for the article code is done by the lost terminal of the finder, or the inquiry registration for the article code is done by the inquiry terminal of the inquirer, notifying the lost terminal is notified of the found terminal or inquiry terminal.

Preferably, to perform the management and processing step, a found article registration step is provided in which finding of the article corresponding to the article code is handled, the found article registration step comprising: an article restriction setup step in which article code restriction is set up on the article code upon a found article registration request for the article code from the found terminal of the finder; an acquisition registration step in which, when a preset acquisition period expires, the found terminal code is matched with the article code and registered, and the article code restriction is lifted; and an article restriction lifting step in which, when the article is collected by the person who lost it before the expiration of the prescription date of acquisition, the article code restriction is lifted.

Preferably, the method of the present invention further comprises a notification step in which, prior to the acquisition registration step, if the ownership registration is done in the registration history database by the lost terminal of the person who lost it, the lost terminal is notified of the found terminal.

Preferably, to perform the management and processing step, a collection registration step is provided in which collection of the article corresponding to the article code is handled, the collection registration step comprising: an article restriction setup step in which article code restriction is set up on the article code upon a collection registration request for the article code from the collected terminal of the collector; a collection step in which, when a preset prescription period of collection expires, the article is collected; a disposal restriction lifting step in which, when a present prescription period of disposal expires, the article code restriction setup on the collected article is lifted; a disposal registration step in which the terminal code of a new owner is matched with the article code and registered upon a disposal registration request for the article code from the collected terminal following the disposal of the article; and an article restriction setup lifting step in which, when the article is collected by the person who neglected it before the prescription period of collection or the prescription period of disposal expires.

Preferably, the method of the present invention further comprises a notification step in which, prior to the article collection or the disposal, if the ownership registration is done by the neglected terminal of the person who neglected it, the neglected terminal is notified of the collected terminal.

Preferably, the method of the present invention further comprises a message transmission step in which, prior to the article restriction setup step, if the article code is registered in ownership, a message for giving a warning against collection is transmitted to the registered terminal for the article.

Preferably, to perform the management and processing step, a management code issuing step is provided in which a unique management code of the article corresponding to the article code is issued, the management code issuing step comprising: a restriction setup confirmation step in which it is checked whether there is article code restriction sep up on the ownership-registered article code, and whether there is article code restriction set up on the registered terminal code; a management code creation step in which, if there is no restriction setup, a management code is created corresponding to the article code by a predetermined method; a management code transmission step of transmitting the management code to the issued terminal along with the article code; and a management code output step in which, if the article code for the article is matched with the article code transmitted to the issued terminal, the issued terminal outputs the management code.

Preferably there is provided a management code inquiry step for inquiring as to whether there is article code restriction set up on the article code corresponding to the management code, the management code inquiry step comprising: a restriction setup confirmation step in which article code restriction is set up on the article code corresponding to the management code upon a management code inquiry request from the inquiry terminal of the inquirer; a first message transmission step in which, if no restriction is set up on the article code, a first message is transmitted along with the article code to the inquiry terminal; a registered terminal code input step in which, if restriction is set up on the article code, a registered terminal code for the article code corresponding to the management code is input from the inquiry terminal; a second message transmission step in which, if the registered terminal code is a confirmed terminal code recognized as having the restriction lifted from the article code, a second message is transmitted along with the article code to the inquiry terminal; and a third message transmission step in which, if the registered terminal code is not a confirmed terminal code recognized as having the restriction lifted from the article code, a third message is transmitted to the inquiry terminal.

Preferably, the method of the present invention further comprises an inquiry notification step in which the registered terminal is notified of an article inquiry made by the inquiry terminal.

### Advantageous Effects

According to the present invention, it is possible to minimize exposure of sensitive personal information, such as name, address, and resident registration number, other than a terminal code, and damage caused by the exposure.

Moreover, it is possible to set up restrictions on a terminal code, as well as on an article code, in case of problems with the reliability of the terminal code, and to increase the security of commercial transactions by allowing a seller to register its ownership of a terminal cord of the seller, checking for any restrictions on the terminal code of the seller and an article concerned before a transaction, and acquiring the terminal code of the seller as a person-in-charge terminal code for the article to enable following-up management.

Furthermore, it is possible to prevent fake ownership registration by permitting no inquiry as to whether an article code is registered so that the fake owner feels as if he or she walks into a trap, in order to prevent the fake owner from registering a fake ownership after inquiring as to whether the article code is registered.

Furthermore, a person inquiring about the article code for a lost or stolen article can be presumed to be a finder of the article or a person related to the article, and the terminal code of that person can be reported to the owner of the article, thereby enabling the collection of the article.

Furthermore, it is possible to trace back responsibility in the event of non-ownership of stolen articles, fake articles, etc. because the owner of an article can get unconditional registration when making a registration request.

Furthermore, if multiple ownership registration requests are made for a single article code, an indirect demand for proof of real ownership can be raised by setting up restrictions on at least one of the article code and the terminal code, and the accumulation of incidents, such as loss/theft, transactions of stolen goods, fraud transactions, etc. is prevented by lifting restrictions on at least one of the article code and the terminal code in the event of real verified ownership, thereby providing an autonomous management function.

### BRIEF DESCRIPTION OF THE DRAWINGS

These and other objects, features, aspects, and advantages of preferred embodiments of the present invention will be more fully described in the following detailed description, taken in conjunction with the accompanying drawings. In the drawings:

FIG. 1 is a block diagram of hardware on which an article management method according to the present invention is implemented;

FIG. 2 is an explanatory view showing an example of a menu shown on a terminal and an example of a typical database used for each menu;

FIG. 3 is a flowchart showing the entire process of the present invention;

FIG. 4 is a flowchart showing the process of the ownership registration step;

FIG. 5 is a flowchart showing the process of an invalid article handling process;

FIG. 6 is a flowchart showing the procedure of the terminal registration step;

FIG. 7 is a flowchart showing the process of the article registration step;

FIG. 8 is a flowchart showing the process of the restriction setup step

FIG. 9 is a flowchart showing the process of the terminal restriction lifting step;

FIG. 10 is a flowchart showing the process of the article restriction lifting step;

FIG. 11 is a flowchart showing the process of the transfer registration process;

FIG. 12 is a flowchart showing the process of the terminal inquiry step;

FIG. 13 is a flowchart showing the process of the article inquiry step;

FIG. 14 is a flowchart showing the process of the loss/theft registration step;

FIG. 15 is a flowchart showing the post-processing process after completion of loss/theft registration;

FIG. 16 is a flowchart showing the process of the found article registration step of the lost article;

FIG. 17 is a flowchart showing the post-processing process after completion of found article registration;

FIG. 18 is a flowchart showing the process of the neglected article registration step;

FIG. 19 is a flowchart showing the post-processing process after completion of neglected article registration; and

FIG. 20 is a flowchart showing the process of the management code issuing step.

### BEST MODE FOR CARRYING OUT THE INVENTION

Hereinafter, an article management method of the present invention will be described in more detail with reference to specific embodiments. The same or similar components having the same functions may be designated by the same or similar reference numerals although they are illustrated in different drawings. Thus, repeated description thereof will be omitted.

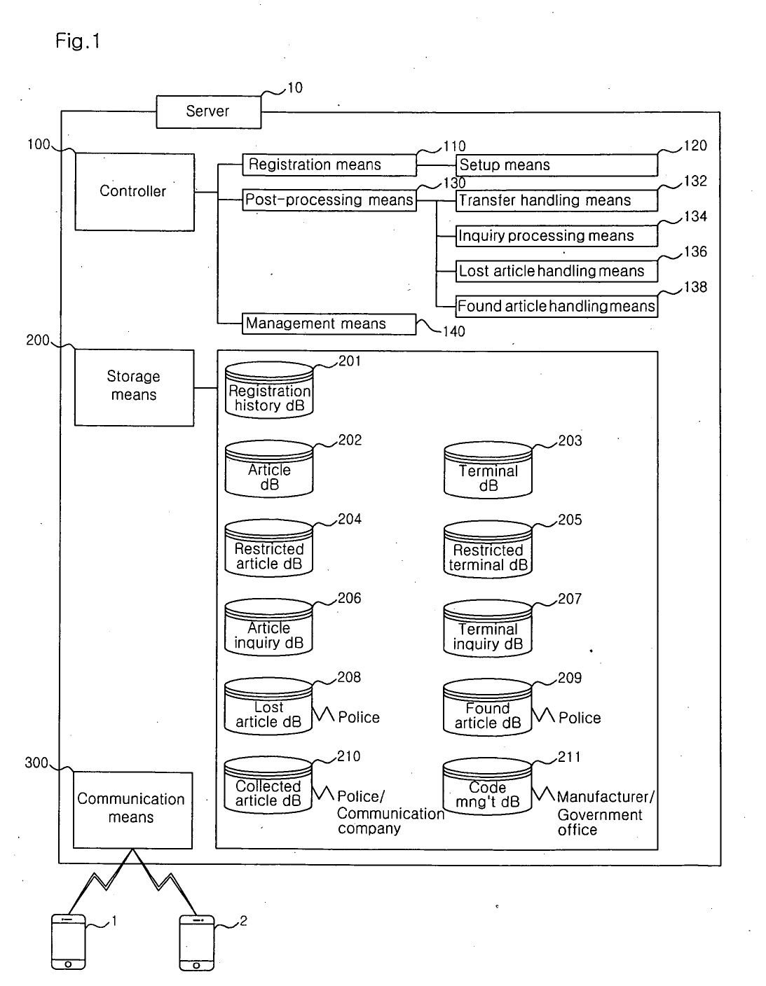

FIG. 1 is a block diagram of hardware on which an article management method according to the present invention is implemented.

The article management method of the present invention can be implemented by a system including a server 10 and terminals 1 and 2.

The server 10 is means for storing an article code for an article and a unique terminal code of an article owner's terminal 1.

Specifically, the server may include controller 100, storage means 200, and communication means 300.

The controller 100 is means equipped with intelligent processing means such as a microprocessor to load and execute a program on which the article management method of the present invention is implemented. The program on which the article management method of the present invention is implemented may be stored in another storage means, or stored in the storage means 200.

Moreover, the controller 100 may be divided by specific functions. For example, the controller 100 may include registration means 110 for performing ownership registration, post-processing means 130 for performing various additional processes on the article code and terminal code registered in ownership, and management means 140 for handling various management items, such as a management history of the article code registered in ownership and a terminal code of a seller, including the issuing of a management code for the terminal code.

For example, the registration means 110 may further include setup means 120 for setting up and lifting restrictions on at least one of an article code and a terminal code in various kinds of registration processes.

Moreover, for example, the post-processing means 130 may further include transfer handling means 132 for performing transfer registration, inquiry processing means 134 for performing an inquiry about at least one of an article code and a terminal code, lost article handling means 136 for handling the loss or theft of an article, found article handling means 138 for handling the finding of a lost article, and collection handling means for handling the collection of a neglected article.

The storage means 200 may be configured to store therein the program on which the article management method of the present invention is implemented. Further, the storage means 200 may be configured to store various types of databases to store a record of various types of handling for article management in a systematical way. For example, the database may include a registration history database 201 for recording the content of ownership registration of an article, an article database 202 for recording an article code, a terminal database 203 for recording a terminal code, restricted article database 204 for recording a article code not permitted to be handled for management, a restricted terminal database 205 for recording a terminal code not permitted to be handled for management, an article inquiry database 206 for recording a history of inquiries about an article code, a terminal inquiry database 207 for recording a history of inquiries about a terminal code, a lost article database 208 for recording the handling of loss or theft, a found article database 209 for recording the handling of a found article, a collected article database 210 for recording the handling of collection of a neglected article, and a code management database 211 for recording various management codes associated with an article code or terminal code and management details such as a valid article code.

The communication means 300 is means equipped in the server 10 for communication with the terminals 1 and 2. The communication means is not limited to one of all communication schemes, such as telephone communication using voice, text communication such as SMS, digital data communication for transmission and reception of a control code, and so on, and one or more of these communication schemes can be combined if available and necessary to perform the article management method of the present invention.

The terminals 1 and 2 are means for connecting to the server 10 by a terminal code. Any types of terminals, including mobile phones, PDAs, and laptops can be used as far as they can be connected to the communication means 300 of the server 10 to conduct communication. Preferably, the terminals 1 and 2 have input means for inputting an article code or terminal code and selecting in the menu. The input means may include all kinds of general devices, such as a keyboard, a mouse, and a pointing device. If an article code is embedded, for example, in an RFID chip, the input means also may include a reader for reading the content of the RFID chip. Moreover, output means for outputting an inquiry result or handling result by voice, display, vibration, etc. is preferably provided.

Hereinafter, description will be made on the assumption that the first terminal 1 refers to a terminal currently registered in ownership, and the second terminal 2 refers to a terminal other than the terminal currently registered in ownership.

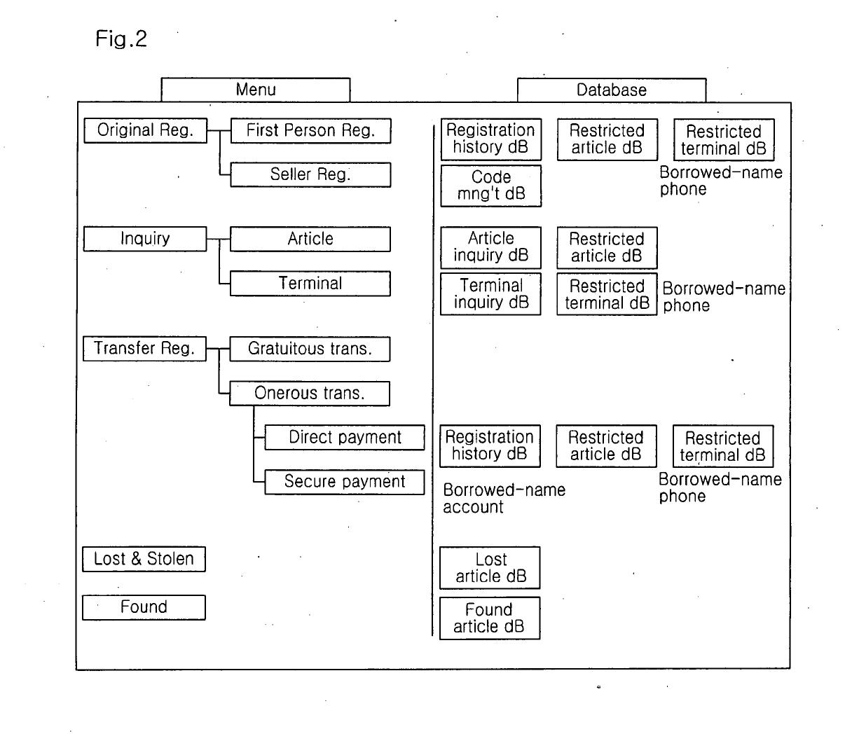

FIG. 2 is an explanatory view showing an example of a menu shown on a terminal and an example of a typical database used for each menu.

For example, if a screen display device is provided as the output means of the terminal 1 registered in ownership, an example of the menu shown on the screen may be as shown in FIG. 2.

‘Original Registration’ means that an article code is registered for the first time. As the ‘Original Registration’, ‘First Person Registration’ and ‘Seller Registration’ can be considered.

The ‘First Person Registration’ means that an article owner has an article registered in his or her name. Entries are an article code desired to be registered in ownership and a terminal code for the owner's terminal 1. At this point, the person who has requested registration and the registrant are the same person. Preferably, the terminal code for the terminal 1 of the person who has requested registration is automatically obtained via communication connection with the server 10 in terms of convenience according to the known art.

The ‘Seller Registration’ means that an article seller has an article registered in the name of the owner, the article purchaser. Entries are an article code desired to be registered in ownership, a terminal code for the owner's terminal 1, and a terminal code for the seller's terminal 2. At this point, the person who has requested registration and the registrant are different. Preferably, the terminal code for the terminal 2 of the seller who has requested registration is automatically obtained via communication connection with the server 10 in terms of convenience according to the known art.

Databases used herein may include the registration history database 201, the article database 202, the terminal database 203, the restricted article database 204, the restricted terminal database 205, and the code management database 211.

‘Inquiry’ is to find out whether any restriction is set up for an article or a terminal. As the ‘Inquiry’, article inquiry as to whether any restriction is set up for an article and terminal inquiry as to whether any restriction is set up for a terminal may be considered. The method of this invention does not permit an inquiry in the article database, that is, a direct inquiry as to whether ownership is registered. The article inquiry database 206, the restricted article database 204, etc. are used for the article inquiry, while the terminal inquiry database 207, the restricted terminal database 205, etc. are used for the terminal inquiry.

‘Transfer Registration’ means that the ownership of a registered article is changed. As the ‘Transfer Registration’, gratuitous transfers, such as inheritance, gifts, etc. and onerous transfers such as sale can be considered. The onerous transfers may include direct payment which helps the person concerned to have their money directly paid and internet secure payment which uses the server 10 to mediate money transfer. For the transfer registration, the registration history database 201, the terminal database 203, the restricted article database 204, and the restricted terminal database 205 are used.

‘Lost and Stolen’ refers to a menu for doing necessary operations in case of loss or theft of an article. The lost article database 208 or the like is used herein.

‘Found’ refers to a menu for doing necessary operations in case an article is found. The found article database 209 or the like is used.

Although not shown, a menu for collecting a neglected article can be displayed on the terminal 2 of a person who has collected a neglected article. It is obvious that a menu for issuing a management code can be displayed on the terminal 2 of a management code issuer.

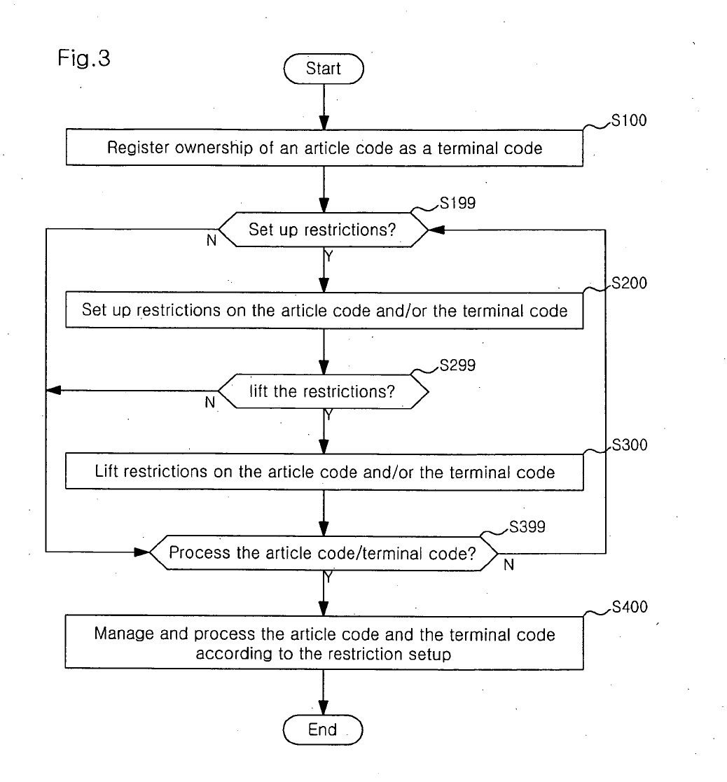

FIG. 3 is a flowchart showing the entire process of the present invention.

Preferably, the article management method of the present invention includes an ownership registration step S100, a restriction setup step S200, a restriction lifting step S300, and a management and processing step S400.

The ownership registration step S100 refers to registering the terminal code to the server 10 as a registration terminal code by matching the terminal code or other terminal code with the article code, upon request from the terminal 1 or 2 for registration of the article code. In this step, although the terminal code and the article code may be matched with each other and stored simply in the storage means 200, it is preferable that they are systematically stored in the registration history database, the article database, and the terminal database.

The restriction setup step S200 refers to setting up restrictions on at least one of the article code and the terminal code when preset conditions for the restriction setup are met. In this step, although the restrictions set up for the terminal code and the article code may be matched with each other and stored simply in the storage means 200, it is preferable that they are systematically stored in the restricted article database and the restricted terminal database.

The restriction lifting step S300 refers to lifting the restrictions on at least one of the article code and the terminal code when preset conditions for the restriction lifting are met. In this step, although the restrictions lifted from the terminal code and the article code may be matched with each other and stored simply in the storage means 200, it is preferable that they are systematically stored in the registration history database, the restricted article database, the restricted terminal database, the lost article database, the found article database, and the collected article database.

The management and processing step S400 refers to enabling management and processing depending on whether the restriction is set up for at least one of the article code and the terminal code when preset management and processing are performed for at least one of the article code and the terminal code, upon request from the terminal 1 or 2 for management and processing. In this step, although the management and processing of the terminal code and the article code may be matched with each other and stored simply in the storage means 200, it is preferable that they are systematically stored in the registration history database, the article database, the terminal database, the restricted article database, the restricted terminal database, the article inquiry database, the terminal inquiry database, the lost article database, the found article database, the collected article database, and the management code database.

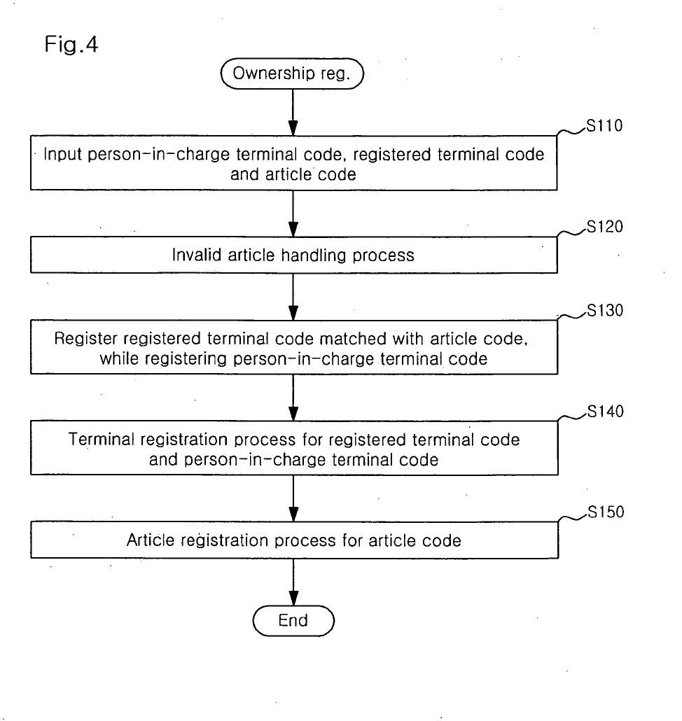

FIG. 4 is a flowchart showing the process of the ownership registration step.

The ownership registration step S100 may be performed in two ways: first-person registration; and seller registration.

In case of first-person registration, the terminal code is registered to the server 10 as a registration terminal code by matching the terminal code with the article code, upon request from the terminal 1 for registration of the article code. Meanwhile, seller registration is initiated upon request from the person-in-charge terminal 2, a terminal of the person-in charge (seller) of the article. The request for ownership registration is a request for issuing ownership registration by matching the article code with the terminal code of the registered terminal 1. According to the ownership registration request, the terminal code for the registered terminal 1 is registered to the server 10 as a registered terminal code by matching the terminal code with the article code, and the terminal code of the person-in-charge terminal 2 is also registered to the server 10 as a person-in-charge terminal code. For the seller registration, it is preferable that pre-registration of a seller code for a reliable seller is allowed.

As used herein, the article code means a unique identification code for an individual article. In the present invention, the article code may be configured according to the types of management targets. Examples of the article code may include a serial number of a Samsung Sense R510 model laptop, a vehicle identity number of a Samchully Bicycle Hound 300D model, and, in case of real estate, 512, Seocho-dong, Gangnam-gu, Seoul.

The article code may be selected in the order of item, manufacturer, type, model, etc from the top-down menu, or may be directly input. For direct inputting, re-checks can be done repeatedly to prevent input error. Moreover, the terminal code refers to a unique identification code for a terminal having communication function. Examples of the terminal code may include a phone number, a MAC address, and a unique hardware number.

One thing in common between the first-person registration and the seller registration is that an article code ends up in being stored in association with a certain terminal code. This means that an article for the article code is an article belonging to the owner of a terminal for the terminal code.

At this point, the terminal of the article owner is referred to as a registered terminal. The person-in-charge terminal refers to a terminal of a person-in charge who is in charge of legal and physical defects of the article. For example, if person A has sold person B an article, person A is a person-in-charge, and person B is a registrant. Also, the terminal of person A is a person-in-charge terminal, and the terminal of person A is a registered terminal.

There are some cases where it is necessary to specify the person-in-charge terminal. For example, the person-in-charge terminal is specified to offer a defect warranty on the article. In this case, it is preferable for volume retailers to perform the process of seller registration.

However, in some cases, the person-in-charge does not need to be specified, or cannot be specified. An example of these cases may include an initially manufactured article or a used article that has been already acquired and owned. In this case, the performance of the first-person registration will suffice.

The procedure of ownership registration will be described in detail below.

First, a person-in-charge terminal code, a registered terminal code, and an article code are input (S110). The person-in-charge terminal code may be omitted for first-person registration, registration obtained by finding a lost article, and registration obtained by collecting a neglected article.

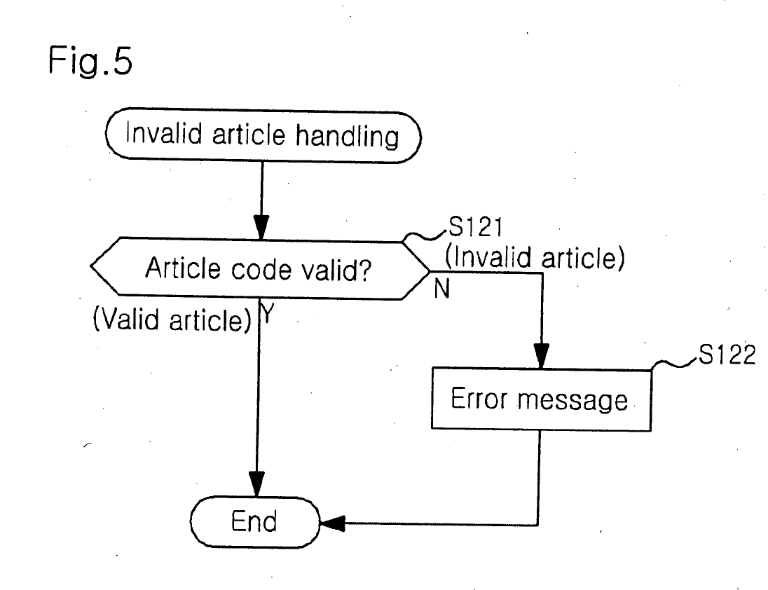

FIG. 5 is a flowchart showing the process of an invalid article handling process.

An invalid article handling process S120 for the article code is performed. At this time, the validity of the article code is determined (S121). The determination can be made by checking whether an input article code belongs to the list or range of article codes issued by the manufacturer. The list or range of article codes issued by the manufacturer may be stored, for example, in an article range database or a code management database 211. Optionally, it may be possible to make an inquiry to the database directly provided by the manufacturer. The structure thereof is as follows.

TABLE 1

| Time | Manufacturer | Model | List/range |
|---|---|---|---|
| Time 10 | A | Camera | 00~99 |
| Time 30 | B | MP3 player | 33, 55, 77, 99 |

If the article code is not valid, an error message, e.g., ‘Code Not Present’ is output (S122), and then the process is finished. According to configurations, an extra database for storing an invalid article code may be provided to perform extra management tasks such as reporting fake articles. The structure thereof is as follows.

TABLE 2

| Serial number | Restricted article (fake) |
|---|---|
| 1 | A |
| 2 | B |
| 3 | C |
| 4 | D |

Afterwards, as a registered terminal code matched with the article code is registered, a person-in-charge terminal code is registered as well (S130). The person-in-charge terminal code may be omitted for first-person registration, registration obtained by finding lost article, and registration obtained by collecting a neglected article.

For ownership registration, for example, the registration history database 101 may be provided, and the structure thereof is as follows.

TABLE 3

| | | | Person-in- | |
|---|---|---|---|---|
| | Article | Registered | charge | |
| Time | code | terminal | terminal | Action code |
| Time 10 | A | A | (A) | Original registration |
| Time 30 | A | B | A | Transfer registration |
| Time 50 | A | C | (C) | Acquisition registration |
| Time 70 | A | D | (D) | Disposal registration |

Herein, time indicates a time stamp representing date and time like 20081225/14:40:56, and may be abbreviated as time 10, time 30, etc. Article code indicates a serial number or identification code like A486386T1110, and may be abbreviated as A, B, C, etc. Terminal code indicates a telephone number like 010-3456-7890 and may be abbreviated as A, B, C, etc. Action code (code of the reason for registration) indicates an enumerative describing what the reason for registration is, and may include four values: original registration, transfer registration, acquisition registration, and disposal registration.

An article registered in the registration history database 201 may be extracted by a registration terminal code, and information about the article may be provided to a registered terminal. For example, searching can be done in the menu ‘View My Article’ according to a hierarchical structure for large, medium, and small categories (layers such as item, type, etc.).

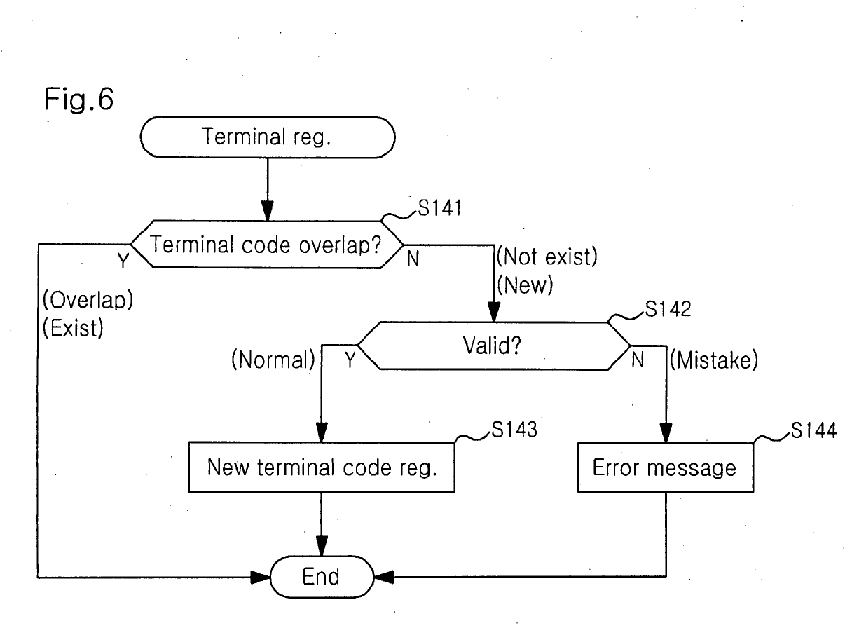

FIG. 6 is a flowchart showing the procedure of the terminal registration step.

Next, a terminal registration process S140 is performed on a registered terminal code and a person-in-charge code.

In the terminal registration process S140 of the ownership registration step, it is determined whether a terminal code was previously registered, that is, an input terminal code overlaps with a previously registered code (S141). If the terminal code has not been registered, it is determined again whether the terminal code is valid (S142). To check the validity of the terminal code, a callback URL message can be sent to the terminal to acknowledge a return message. By this, it is possible to prevent an input error and prevent invalid use, such as the use of a terminal under disguised ownership, the use of a borrowed-name phone, etc. Preferably, new terminal code registration S143 is performed on the terminal code only in a case that the terminal code is valid. Unless validity is admitted, an error message is output (S144), and the process is finished. Otherwise, a re-input can be requested.

For registration of the terminal code, for example, the terminal database 203 may be provided, and the structure thereof is as follows.

TABLE 4

| Serial number | Terminal code |
|---|---|
| 1 | A |
| 2 | B |
| 3 | C |
| 4 | D |

If the registered terminal code of the registrant is changed, for example, a phone number cancellation or change occurs, all the article codes belonging to the current registered terminal code need to be automatically transferred to a new registered terminal code as far as the cancellation or change is reasonably proved.

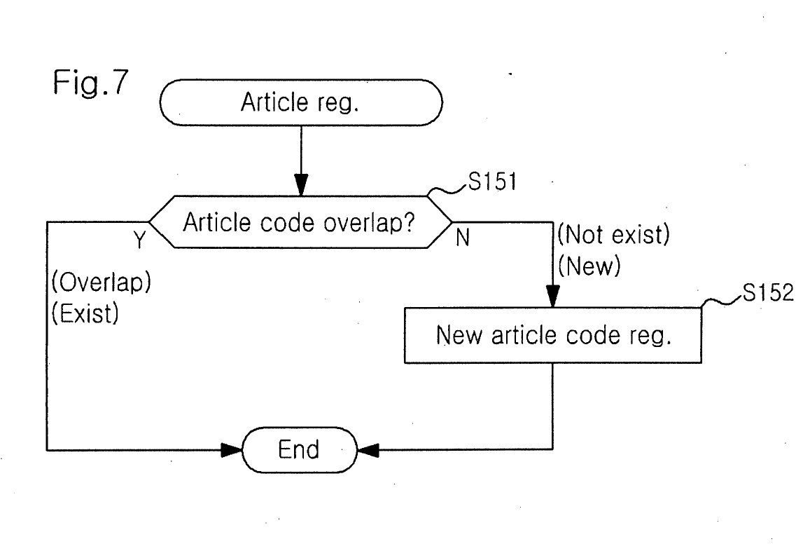

FIG. 7 is a flowchart showing the process of the article registration step.

Next, in the article registration process of the ownership registration step, it is determined whether an input article code overlaps with the article code determined as valid through the invalid article handling process S120 (S151). If the terminal code has not been registered, it is preferable to perform new article code registration S152 on the article code.

TABLE 5

| Serial number | Article code |
|---|---|
| 1 | A |
| 2 | B |
| 3 | C |
| 4 | D |

If the article for the registered article code is changed, for example, article loss occurs, the deletion of the article code or the setup of a deletion flag need to be done based on the current status of the article.

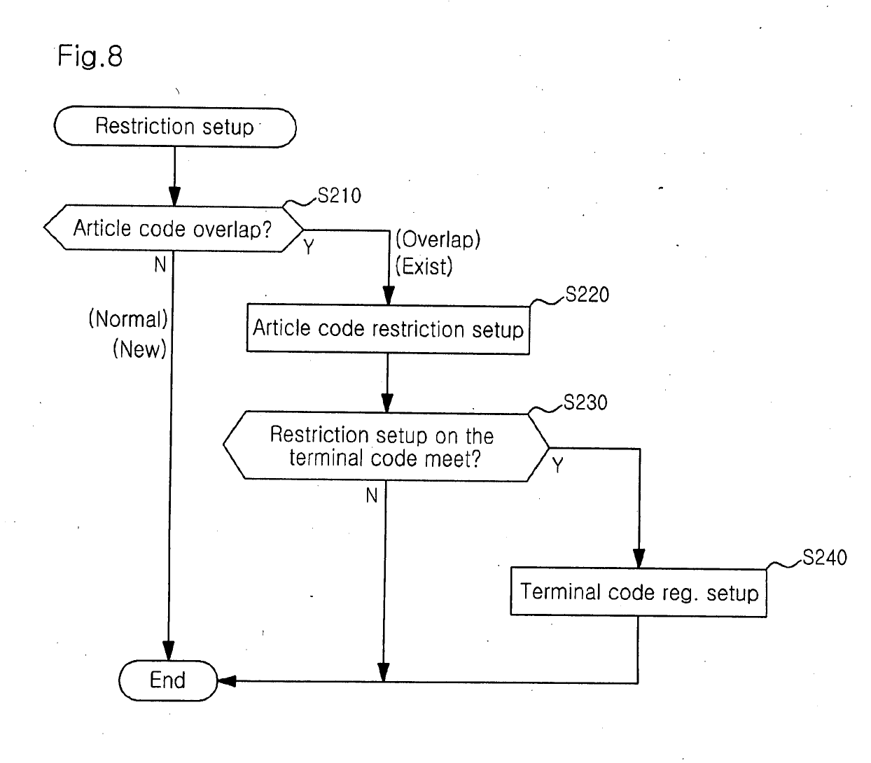

FIG. 8 is a flowchart showing the process of the restriction setup step.

When ownership registration (S100) is completed, it is determined whether preset conditions for the restriction setup are met (S199). If the preset conditions for the restriction setup are met, the restriction setup step S200 is performed.

In the restriction setup step S200, it is determined whether the article code desired to be registered in ownership overlaps a previously registered article code (S210). If so, it is preferable that the article code restriction setup S220 is performed on the overlapping code.

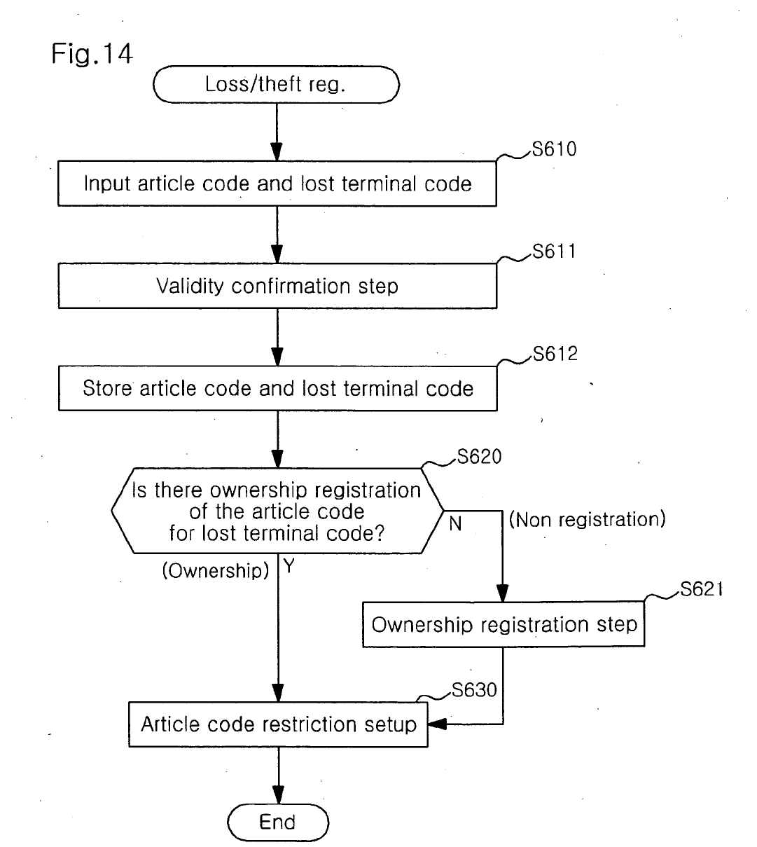

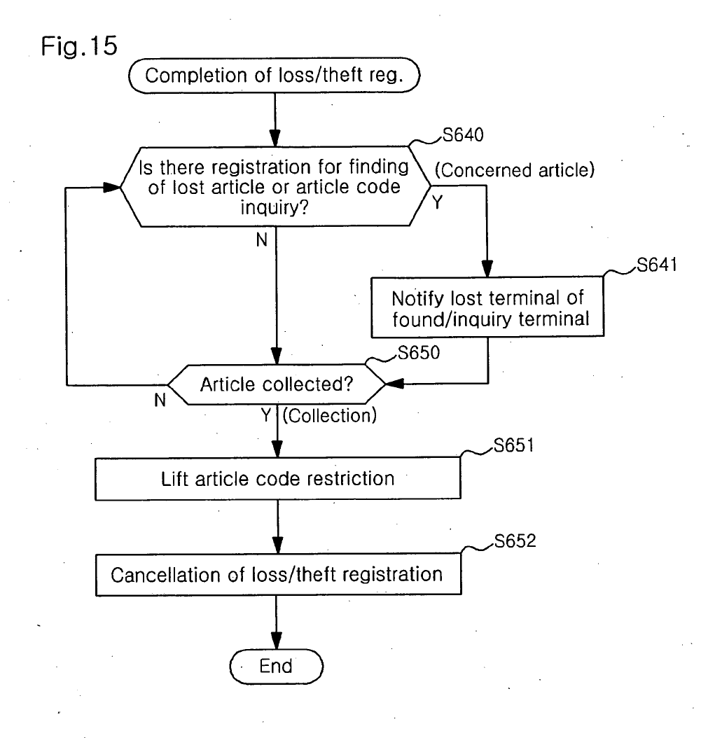

If there is an article code overlap at the time of ownership registration, it will be convenient if a question is asked whether to perform loss/theft registration on the terminal registered in ownership. If a response wanting to perform both loss/theft registrations is given, the loss/theft registration process of FIGS. 14 and 15 is performed.

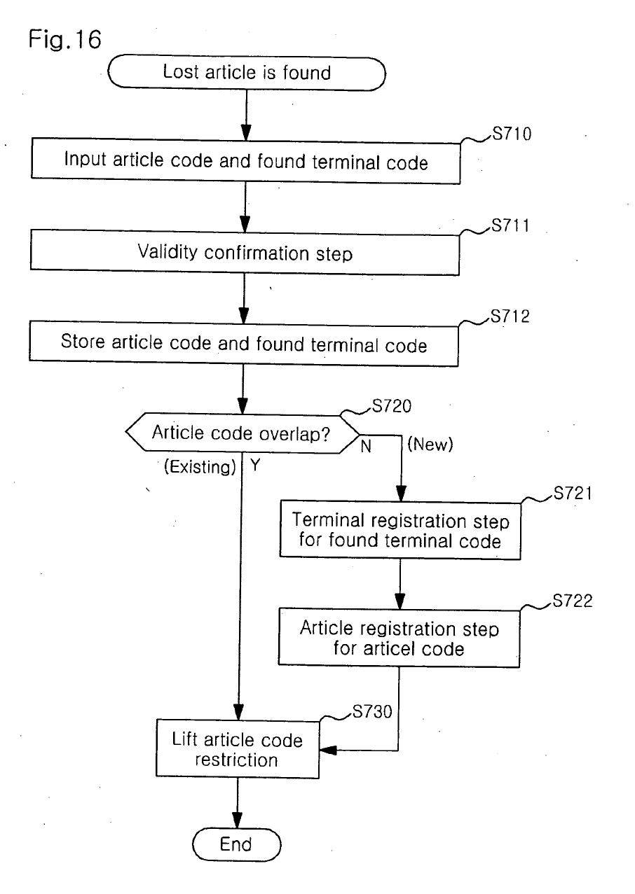

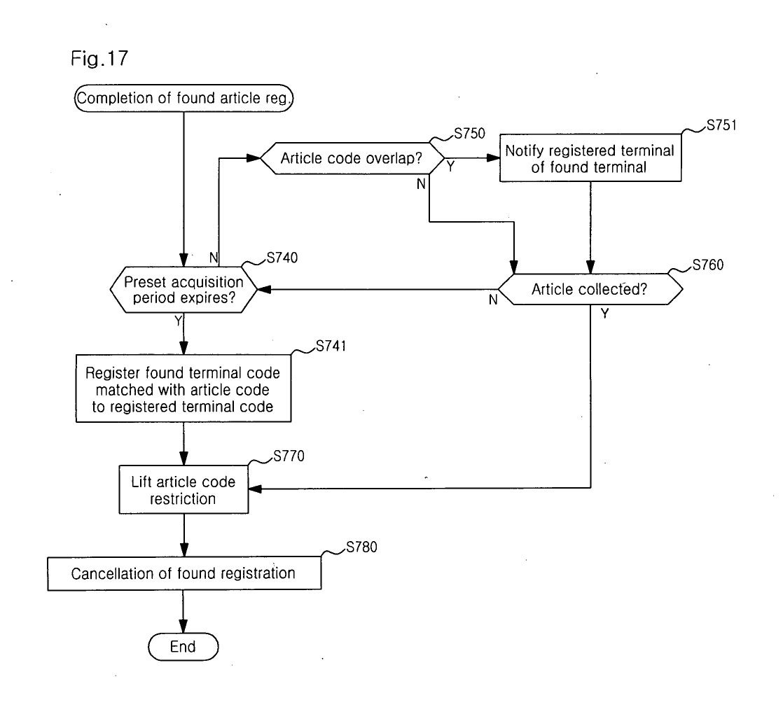

If an article code overlap occurs at the time of ownership registration, and loss/theft registration has been already done, it is very likely that the ownership registration causing the article code overlap was not done by the real owner of a stolen article, a found article, etc. Accordingly, a message indicating that another ownership registration has been done on the lost/stolen article may be transmitted to the terminal of the person who has a loss or theft registered, or a message indicating that the ownership registration and the loss/theft registration have been done may be transmitted to the terminal of the person who registered his or her ownership. Moreover, it will be convenient if a question is asked whether to perform found article registration on the terminal causing the article code overlap. If a response wanting to perform both found article registration is given, the found article registration process of FIGS. 16 and 17 is performed.

For registration of the restricted article code, for example, the restricted article database 204 may be provided, and the structure thereof is as follows.

TABLE 6

| Serial number | Restricted article | Confirmed terminal |
|---|---|---|
| 1 | A | A |
| 2 | C | |
| 3 | E | B |

Herein, a confirmed terminal code refers to a terminal code for a terminal permitted for management and processing of the article code, despite that the article is a restricted one. For example, if the article code is restricted because of many fake articles, as well as a genuine article with the same article code, there exists only one genuine article. Accordingly, when the owner of the genuine article has the genuine article verified and registered, the terminal code for the terminal of the genuine article owner is confirmed. Although this article code is basically restricted, it is not completely restricted for this confirmed terminal code, thereby enabling management and processing.

For the management of the article authenticated or confirmed as genuine, a genuine article confirmation database may be provided, and the structure thereof is as follows.

TABLE 7

| Time | Confirmed terminal code | Genuine article code |
|---|---|---|
| Time 10 | A | A |

If there is an owner who has an article authenticated as genuine, the article code of another owner who has his or her ownership registered in the same article code may be regarded as fake. If there is an article code overlap after authentication of the genuine article, it is preferable that restriction is setup on the registered terminal of the person who registered ownership, which causes the overlap, and the restriction on the registered terminal of the person who holds authentication of the genuine article is lifted. In this case, the fake articles may be separately stored and managed in a false article database, and the structure thereof is as follows.

TABLE 8

| Serial number | False article code | Registered terminal |
|---|---|---|
| 1 | A | A |
| 2 | A | B |
| 3 | B | C |
| 4 | | |

Then, it is determined whether preset conditions for the restriction setup on the terminal code are met (S230). If the preset conditions for the restriction setup on the terminal code are met, a terminal code restriction setup S240 is preferably performed on the terminal code registered in ownership.

For the registration of the restricted terminal code, the restricted terminal confirmation database 205 may be provided, and the structure thereof is as follows.

TABLE 9

| Serial number | Restricted terminal |
|---|---|
| 1 | A |
| 2 | C |
| 3 | E |
| 4 | G |

Especially, to extract illegal terminals, so-called borrowed-name phones or lost or stolen phones, and set up restrictions on them, if the number of times of designation of a terminal as a restricted terminal exceeds a reference value, this terminal is presumed to be a borrowed-name phone. The terminal code is registered in a borrowed-name database, and the borrowed-name database can be used in combination with the restricted terminal database 205. Moreover, an inquiry as to the terminal codes of the borrowed-name database is made to the communications company, and restrictions can be imposed on all other terminal codes under the ownership of the same name.

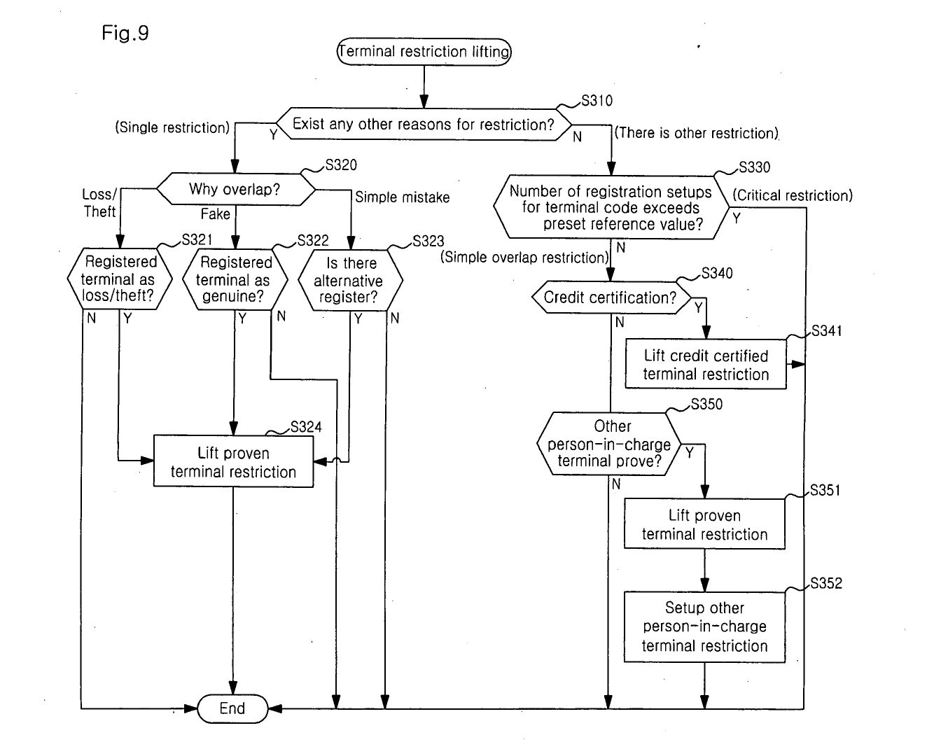

FIG. 9 is a flowchart showing the process of the terminal restriction lifting step.

In the case that the restrictions are set up as above, it is determined whether preset conditions for the restriction setup are met (S299). Once the preset conditions for the restriction setup are met, the restriction lifting step S300 is performed. The preset conditions for the restriction setup are met when checking of data, as recorded in the corresponding database, is not available, for example, like in reference, credit certification, etc., the restrictions can be lifted upon receipt of a cancellation command inputted from a server administrator who has accepted the implementation of those tasks in an external process.

If a restriction is set up for the terminal code, it is determined whether there exists any other reason for the restriction on the terminal code associated with the overlapping article code in the restriction lifting step (S310). If there is no other reason for the restriction, terminal code restriction lifting can be done after determining whether other conditions are met as follows, for example:

If the article code overlap is caused by loss registration or theft registration, terminal code registration lifting can be performed on the terminal code for the terminal 1 registered as lost or stolen. That is, in the case where the article has been already registered as lost or stolen before ownership registration is performed, the article code overlap occurs during the ownership registration, thereby performing the terminal code restriction setup. However, the person who has performed the loss registration or theft registration claims himself or herself to be the owner, it is very likely the person who caused the ownership registration overlap is the person who has found the article but registered his or her ownership. Accordingly, the restriction setup on the terminal code for the terminal 1 of the person who lost the article or had the article stolen can be lifted.

If the article code overlap is caused by ownership registration of a false article, terminal code registration lifting can be performed on the terminal code for the confirmed terminal, i.e., the terminal 1 proven to be and registered as genuine. That is, if a plurality of people have registered the ownership of articles with the same article code, and there is no loss/theft registered from each of the terminals with registered ownership, this can be viewed as an ownership registration overlap. At this point, if the article code is restricted because of many fake articles, as well as a genuine article with the same article code, the owner of the genuine article has the genuine article verified and registered. Then, the terminal code for the terminal of the genuine article is confirmed. In this case, although this article code is basically restricted, it is not completely restricted for this confirmed terminal code, thereby enabling management and processing.

If the article code overlap is caused by multiple ownership registrations, for example, all the members of a family have registered their ownership of a single article, terminal code restriction lifting can be performed on the terminal codes for all the terminals 10 with registered ownership associated with alternative declaration that only one of the multiple ownership registrations is valid. That is, if it is decided to revert the article to only one terminal by the consent of the plurality of people who have registered their ownership, there is a need to lift the restriction on the terminal codes for all the terminals they agreed on.

Meanwhile, in the restriction lifting step S300, if a restriction is set up for the terminal code, it is determined whether there exists any other reason for the restriction on the terminal code associated with the overlapping article code. If there is other reason for the restriction, it is determined whether the number of registration setups for the terminal code exceeds a preset reference value. If a large number of restriction setups exceeding the reference value are put on the terminal code, it is very likely the terminal is an illegal terminal, a so-called borrowed-name phone, and therefore the restriction setups have to be maintained. Accordingly, only a terminal having restriction setups less than the reference value needs to be a candidate for restriction lifting.

If the number of restriction setups is less than the reference value, terminal code restriction lifting can be done after determining whether other conditions are met as follows, for example:

Terminal code registration lifting can be performed on the terminal code for the terminal 1 that has registered credit certification and identity. That is, the terminal code has been verified by government agencies, such as the police, or another reputable organization, the restriction on the terminal can be lifted. To mange a terminal that has registered credit certification and identify, a identification database is preferably provided, and the structure thereof is as follows.

TABLE 10

| Time | Confirmed terminal |
|---|---|
| Time 10 | A |

(2) Terminal code restriction lifting can be performed on the terminal code for the terminal 1 for which it has been proven that the person-in-charge terminal 2 is responsible for the article code overlap. Preferably, terminal code restriction setup can be performed for the terminal code of the person-in-charge terminal 2. That is, although the restriction is set up on the terminal code for the registered terminal due to the article code ownership registration of the registered terminal 1, this registered terminal is merely a terminal of the purchaser who is the victim. If the proof that the person-in-charge terminal 2 is responsible for the overlap is accepted through receipt, for example, the restriction setup on the registered terminal 1 is lifted, and the a new registration setup is performed on the person-in-charge terminal 2. For reference, if there is an overlap in ownership registration between seller registration and person-in-charge terminal registration, restriction can be set up on the person-in-charge terminal, as well as on the registered terminal, or restriction can be set up not on the registered terminal but on the person-in-charge terminal.

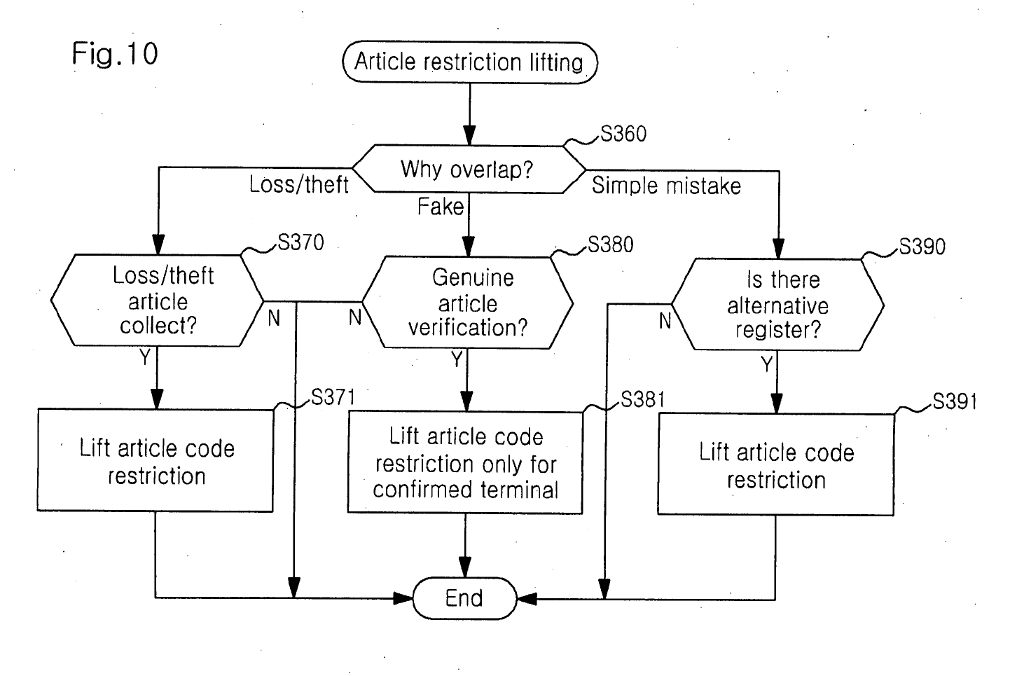

FIG. 10 is a flowchart showing the process of the article restriction lifting step.

If restriction has been set up on the article code in the restriction lifting step S300, the cause of an article code overlap may be determined and the article code restriction may be lifted as follows:

If the article code overlap is caused by loss registration or theft registration, terminal code registration lifting can be performed when the article registered as lost or stolen is collected. That is, there is a need to lift the restriction because the reason for the article code restriction setup is fundamentally eliminated.

If the article code overlap is caused by ownership registration of a false article, terminal code registration lifting can be performed on the terminal code for the confirmed terminal, i.e., the terminal 1 proven to be and registered as genuine. That is, the article code restriction setup does not need to be maintained to allow the confirmed terminal verified as genuine to perform management and processing.

If the article code overlap is caused by multiple ownership registrations only a mistake, terminal code restriction lifting can be performed as far as alternative declaration is made that only one of the multiple ownership registrations is valid. That is, there is no need to maintain the restriction on the article whose possibility of dispute is eliminated by consent.

Hereinafter, a concrete example of a variety of preset processes in the management processing step will be discussed.

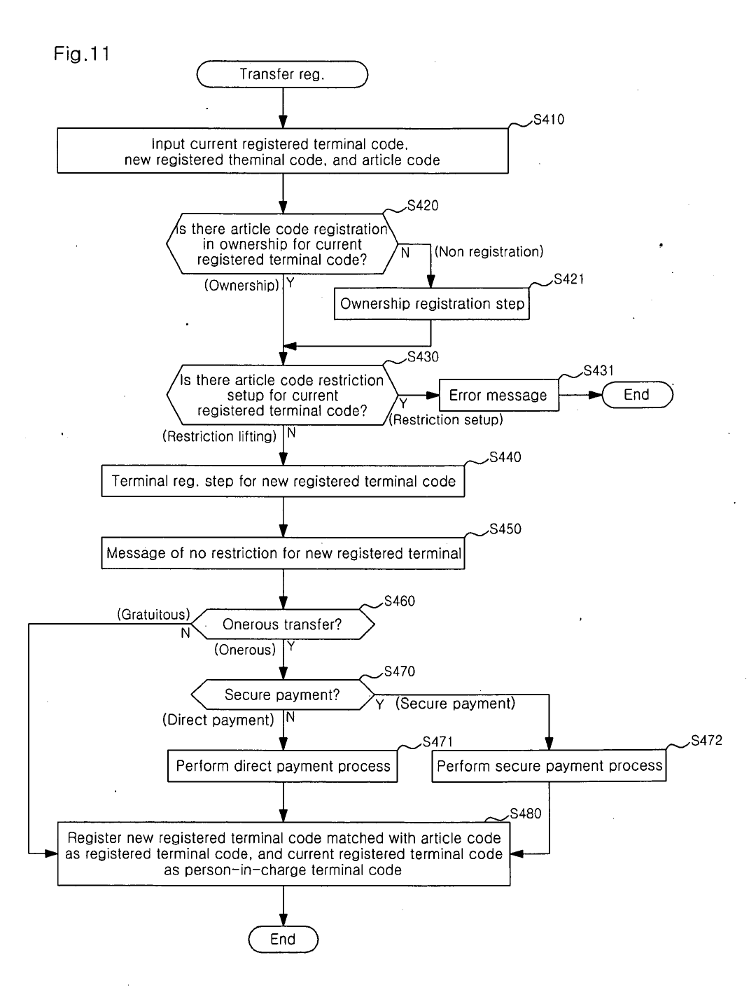

FIG. 11 is a flowchart showing the process of the transfer registration process.

To perform the management and processing step, a transfer registration step is provided in which the article code registered in ownership corresponding to the current registered terminal code is changed to correspond to a new registered terminal code and registered.

Preferably, the transfer registration step includes a restriction setup confirmation step S430, a message transmission step S450, a transfer registration execution confirmation step, and a change registration step S480.

The restriction setup confirmation step S430 is initiated upon a transfer registration request S410 from the current registered terminal 1 that requests to change the article code to an article code for the new registered terminal 2 and register the new article code. The article code may be selected from a property list of the ‘View My Article’ menu of the current registered terminal 1, or may be directly input. At this point, the terminal code of the new registered terminal 2 is also input. Preferably, the terminal code of the current registered terminal 1 is automatically acquired via connection with the server according to the well-known art.

If the current registered terminal code and the article code have not been registered in ownership yet (S420), menu selection is not available. Thus, it is necessary to directly input the article code. To this end, the ownership registration step S421 (i.e., S100) may be performed. At this point, the registration history database 201 can be used. An action code is original registration. Otherwise, if a transfer registration request has been made in spite of non-registration, an error message is output. Also, the transfer registration step may be forcibly performed after the ownership registration step.

Afterwards, it is confirmed that no restriction is set up on the article code and no restriction on the terminal code is set up on the current registered terminal code (S430). The restricted article database 204 and the restricted terminal database 205 may be used. If there is a restriction on any of them, an error message is output (S431), and the procedure is finished.

If there is no restriction setup at all, the terminal registration step S440 (i.e., the process of FIG. 6) of the new registered terminal code in the terminal database 203 is carried out.

The message transmission step S450 is a step in which, if there is no restriction setup, a message indicating that there is no restriction on transfer registration, i.e., the availability of transaction, is transmitted to the terminal 2 of the new registered terminal code.

The transfer registration execution confirmation step is a step in which a transfer registration execution request is received from the current registered terminal code and the new registered terminal code.

The change registration step S480 is a step in which the new registered terminal code is matched with the article code and registered, and the current registered terminal code, too, is registered as a person-in-charge terminal code. The registration history database 201 can be used. An action code is transfer registration.

Herein, if the transfer registration is onerous transfer registration, it is preferable that direct payment or secure payment can be selected. If secure payment is selected, it is preferable that the transfer registration execution confirmation step is followed by a secure payment process in which deposited money is transferred after receiving a money transfer execution request from the current registered terminal code and the new registered terminal code.

The secure payment will be described briefly though it is a well-known art. The terms of contracts, such as money amount, period for return of defective items, etc., are notified to both parties and confirmed, and then a deposit account number is input from the seller and an account number for a refund is input from the purchaser. Then, a temporary account is prepared in the server. When the purchaser puts money into the temporary account, the purchaser sends the article to the purchaser. After that, when acceptance is input from both parties, the money in the temporary account is transferred to the seller's deposit account. Unless acceptance from both parties is input, the money in the temporary account is transferred to the purchaser's account for a refund.

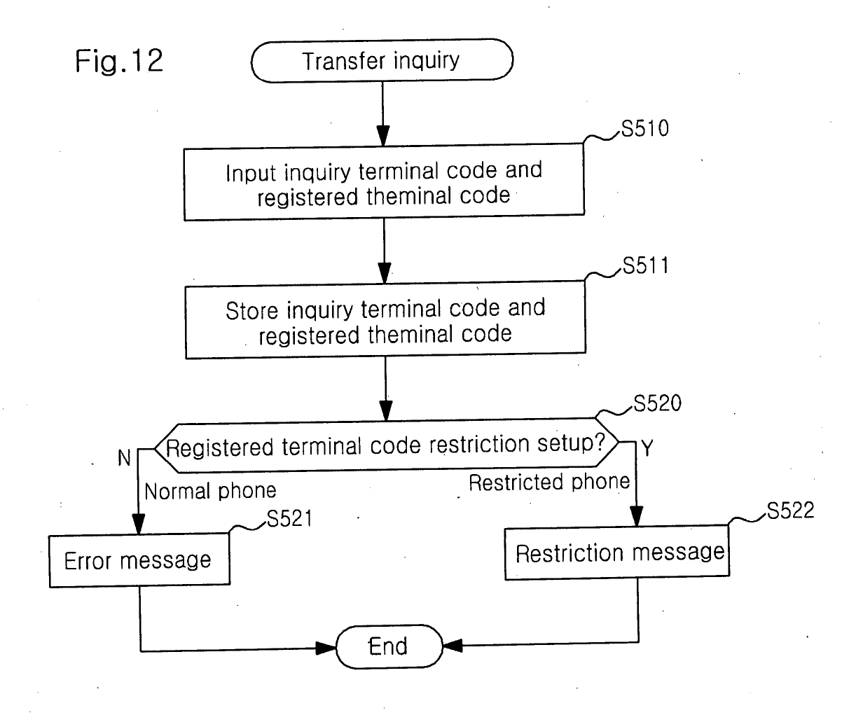

FIG. 12 is a flowchart showing the process of the terminal inquiry step.

To perform the management and processing step, a terminal inquiry step is provided in which an inquiry is made as to whether restriction is set up on the terminal code registered in ownership.

Preferably, the terminal inquiry step includes a restriction setup confirmation step and a message transmission step.

The restriction setup confirmation step is a step in which it is checked whether (S520) restriction is setup on the registered terminal code upon a terminal inquiry request (S510) from the inquiry terminal 2 of the inquirer. Preferably, the inquiry terminal code is automatically extracted and input according to the well-known art. Whether restriction is setup or not can be determined by searching the restricted terminal database 205. Also, an inquiry can be made as to whether the terminal is a borrowed-name phone by using a borrowed-name database.

To store (S511) the inquiry terminal code and the registered terminal code, a terminal inquiry database 207 is preferably provided. The structure thereof is as follows.

TABLE 11

| Time | Registered terminal | Inquiry terminal |
|---|---|---|
| Time 10 | A | B |

The message transmission step is a step in which, if no restriction is set up on the registered terminal code, a first message, e.g., a message ‘no restriction set up on this terminal’ is transmitted to the inquiry terminal 2, and if restriction is setup on the registered terminal code, a second message, e.g., ‘restriction set up on this terminal’ or ‘borrowed-name phone’ is transmitted to the inquiry terminal 2.

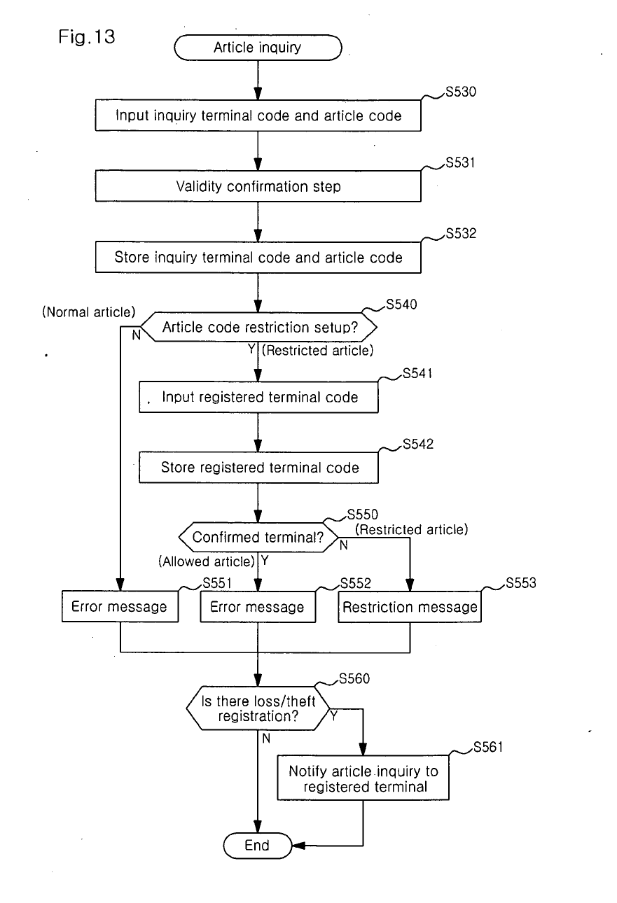

FIG. 13 is a flowchart showing the process of the article inquiry step.

To perform the management and processing step, an article inquiry step is provided in which an inquiry is made as to whether restriction is set up on the article code registered in ownership. The article inquiry is supposed to be performed by a finder of the article or a person who will buy the article. Besides, it can be expected that a person who acts like a fraudster to receive a reward for reporting a fake article might make an inquiry.

Preferably, the article inquiry step includes a restriction setup confirmation step S540, a first message transmission step S551, a registered terminal code input step S541, a second message transmission step S552, and a third message transmission step S553.

The restriction setup confirmation step S540 is initiated upon an article inquiry request S530 from the inquiry terminal 2 of the inquirer. Preferably, the inquiry terminal code is automatically extracted and input via connection with the server 10 according to the well-known art. Preferably, the validity confirmation step S531 (i.e., FIG. 5) of the input article code is performed.

To store (S532) the inquiry terminal code and the registered terminal code, an article inquiry database 206 is preferably provided. The structure thereof is as follows.

TABLE 12

| | Inquiry article | Registered terminal | Inquiry terminal |
|---|---|---|---|
| Time | code | code | code |
| Time 10 | A | A | B |

Next, it is checked whether restriction is set up on the article code (S540). A restricted article database 204 may be used.

The first message transmission step S551 is a step in which, if no restriction is set up on the article code, a first message, e.g., a message ‘unconfirmed’ is transmitted to the inquiry terminal 2. The reason why a message such as ‘unconfirmed’ is outputted despite that the article is a normal article is to prevent illegal registration of an article code by taking advantage of article code inquiry. In the present invention, whether the article code is registered in ownership or not is kept confidential.

The registered terminal code input step S541 is a step in which, if restriction is set up on the article code, a registered terminal code for the article code corresponding to the management code is input from the inquiry terminal 2. The registered terminal code is also stored in the article inquiry database 206 (S542). More preferably, it is checked if there is any confirmed terminal whose restriction setup on the article code is lifted. That is, a registered terminal code input is received only when there is a confirmed terminal, thereby alleviating the inconvenience of input by the inquirer.

The second message transmission step S552 is a step in which, if the registered terminal code is a confirmed terminal code recognized as having the restriction lifted from the article code S550, a second message, for example, a message ‘transaction available’, is transmitted to the inquiry terminal 2. As described above, the confirmed terminal code may be stored in the restricted article database 204.

The third message transmission step S553 is a step in which, if the registered terminal code is not a confirmed terminal code recognized as having the restriction lifted from the article code, a third message, for example, a message ‘overlapping article’ or ‘restricted article’, is transmitted to the inquiry terminal 2.

Preferably, an inquiry notification step S561 is further provided in which the registered terminal 1 is notified of an article inquiry made by the inquiry terminal 2. This is because it is very likely that the inquirer is a finder. In the inquiry notification step S561, it is possible to find the registered terminal 1 with reference to the registration history database 201. Especially, this step is more effective when there is loss/theft registration (S560). Thus, it is also preferable to refer to the loss database 208.

FIG. 14 is a flowchart showing the process of the loss/theft registration step, and FIG. 15 is a flowchart showing the post-processing process after completion of loss/theft registration.

To perform the management and processing step, a loss registration step is provided in which loss or theft of an article corresponding to the article code is handled. If there is an article code overlap in the ownership registration step, it is checked whether to automatically perform the loss registration step. If acknowledgement is received, the loss registration step can be performed along with the ownership registration step.

Preferably, the loss registration step includes an article restriction setup step S630 and an article restriction lifting step S651.

The article restriction setup step S630 is initiated upon a loss registration request S610 for the article code from the lost terminal 1 of the person who lost it. Preferably, the lost terminal code is automatically extracted and input via connection with the server 10 according to the well-known art. Although the article code may be directly input, it may be selected from its own property list arranged by large, medium, and small categories in a top-down manner in the menu of the lost terminal 1 which is a registered terminal. Also, a reward to be given to an information provider who helps to collect the lost article can be registered too. Preferably, validity check can be done on the input article code (S611, i.e., FIG. 5).

To store (S612) the article code and the lost terminal code, a loss article database 208 is preferably provided. The structure thereof is as follows.

TABLE 13

| | Article | Registered | Reward | Time of |
|---|---|---|---|---|
| Time | code | terminal | amount | collection |
| Time 10 | A | A | 1,000,000 Wons | Time 30 |

If ownership registration of the article code for the lost article code has not been performed yet (S620), the ownership registration step S621 (i.e. S100) can be performed by original registration of action code in the registration history database 201. Moreover, since the article is not under control of the owner any more, the article code restriction setup S630 is performed on the article code in the restricted article database 204.

The article restriction lifting step S651 is a step in which, when the article is collected by the person who lost it (S650), the article code restriction is lifted in the restricted article database 204 (S651). Preferably, the cancellation of the loss/theft registration is also recorded in the loss database 208. To this end, the loss/theft registration record may be deleted, or may be simply displayed in a cancellation flag, or the time of collection may be recorded as illustrated.

Prior to the collection S650 of the article, if the found article registration S640 for the article code of the lost article is done by the lost terminal 2 of the finder, or the inquiry registration S640 for the article code is done by the inquiry terminal 2 of the inquirer, it is preferable to further provide a notification step S641 for notifying the lost terminal 1 of the found terminal 2 or inquiry terminal 2. By this, the collection of the article can be facilitated. Before the notification, consent from the finder or the person who makes an inquiry may be required.

FIG. 16 is a flowchart showing the process of the found article registration step of the lost article, and FIG. 17 is a flowchart showing the post-processing process after completion of found article registration.

To perform the management and processing step, a found article registration step is provided in which finding of the article corresponding to the article code is handled.

Preferably, the found article registration step includes an article restriction setup step S730, an acquisition registration step S740, and an article restriction lifting step S760.

The article restriction setup step S730 is initiated upon a found article registration request for the article code from the found terminal 2 of the finder. Preferably, the found terminal code is automatically extracted and input via connection with the server 10 according to the well-known art. Preferably, the validity confirmation step S711 (i.e., FIG. 5) of the input article code is performed.

To store (S712) the article code and the found terminal code, the found article database 209 is preferably provided. The structure thereof is as follows.

TABLE 14

| | | Found terminal | Time of | Time of |
|---|---|---|---|---|
| Time | Article code | code | publication | acquisition |
| Time 10 | A | B | Time 30 | Time 50 |

If ownership registration of the article code has not been performed yet (S720), the terminal registration step S721 (i.e., FIG. 6) of the found terminal code and the article registration step S722 (i.e., FIG. 7) of the article code can be performed. Moreover, since the article is not under control of the owner any more, the article code restriction setup S730 is performed on the article code in the restricted article database 204. At the same time, a predetermined message may be sent to a police terminal to report theft.

In the acquisition registration step S740, when a preset acquisition period expires (S740), the expiration of the prescription period of acquisition period is recorded in the found article database 209, and the found terminal code is matched with the article code and registered in the registration history database 201 under the action code of acquisition registration (S741), and the article code restriction is lifted in the restriction article database 201 (S770). The prescription period of acquisition is, for example, 1 year since the date of publication, and thus it is preferred to record the time of publication. Preferably, the time of publication is notified to the found terminal.

In the article restriction lifting step S770, when the article is collected (S760) by the person who lost it before the expiration of the prescription date of acquisition (S740), the article code restriction is lifted in the restricted article database 204.

Preferably, the cancellation of found article registration is recorded in the found article database 209 (S780). To this end, the found article registration record may be deleted, or may be simply displayed in a cancellation flag, or the time of acquisition may be recorded as illustrated.

Prior to the acquisition registration step, if the ownership registration is done in the registration history database 201 by the lost terminal 1 of the person who lost it, that is, an article code overlap occurs in the article database 202 (S750), it is preferable to further provide a notification step S751 for notifying the lost terminal 1, which is registered, of the found terminal 2. Alternatively, contrariwise, the registered terminal may be notified to the found terminal 2. By this, the collection of the article can be facilitated. If the owner already has done loss registration before the acquisition registration, a reward amount, as well as the registered terminal, may be notified to the found terminal.

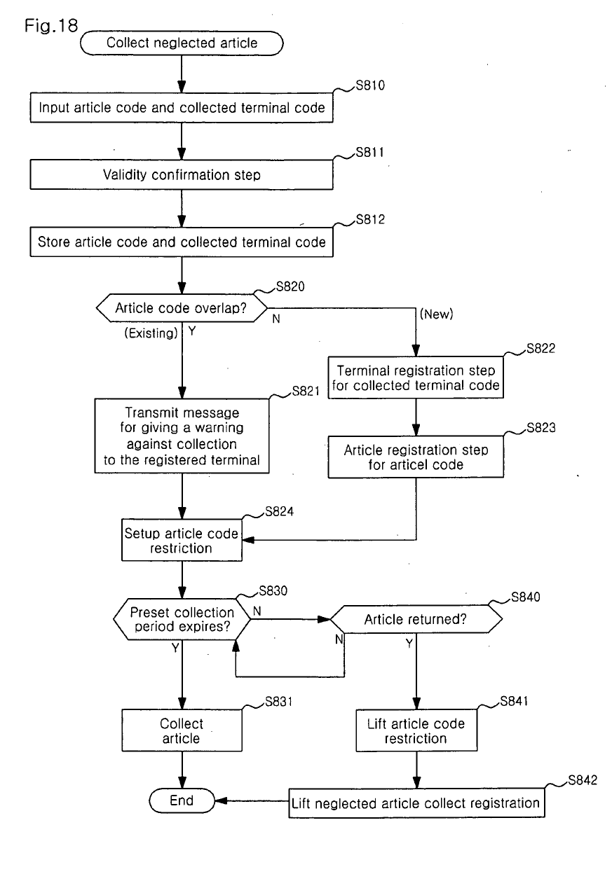

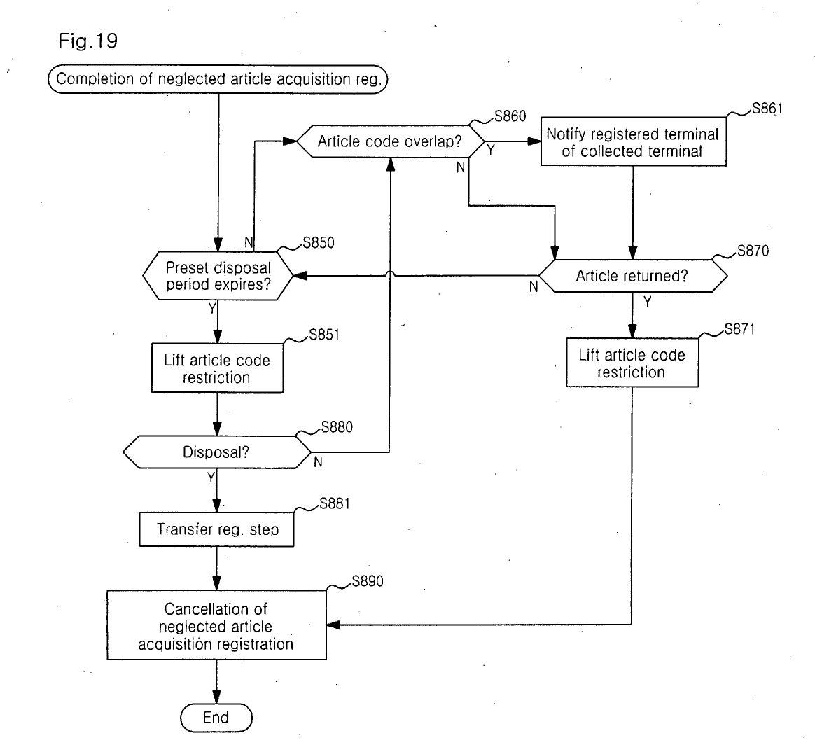

FIG. 18 is a flowchart showing the process of the neglected article registration step, and FIG. 19 is a flowchart showing the post-processing process after completion of neglected article registration.

To perform the management and processing step, a collection registration step is provided in which collection of the article corresponding to the article code is handled.

Preferably, the collection registration step includes an article restriction setup step S730, a collection step S831, a disposal registration lifting step S851, a disposal registration step S881, and an article restriction lifting step S871.

The article restriction setup step S824 is initiated upon a collection registration request for the article code from the collected terminal 2 of the collector. The collection registration request may be performed along with putting a sticker for giving a warning against collection. Preferably, the collected terminal code is automatically extracted and input via connection with the server 10 according to the well-known art. Preferably, the validity confirmation step S811 (i.e., FIG. 5) of the input article code is performed.

To store (S812) the article code and the collected terminal code, the found article database 210 is preferably provided. The structure thereof is as follows.

TABLE 15

| | | Collected | | | |
|---|---|---|---|---|---|
| Time of | | terminal | Time of | Time of | Time of |
| warning | Article code | code | collection | publication | disposal |
| Time 10 | A | B | Time 30 | Time 50 | Time 70 |

If ownership registration of the article code has not been performed yet in the registration history database 201, i.e., there is no article code overlap in the article database 202 (S820), the terminal registration step S822 (i.e., FIG. 6) of the collected terminal code and the article registration step S823 (i.e., FIG. 7) of the article code can be performed. Moreover, since the article is not under control of the owner any more, the article code restriction setup S824 is performed on the article code in the restricted article database 204.

In the collection step S831, when a prescription period of collection preset in the collection database 210 expires (S830), the article is collected (S831). For example, manpower for collection is called for by an alarm indicative of the expiration of the prescription period of collection.

In the disposal restriction lifting step S851, a prescription period of disposal preset in the collection database 210 expires, for example, 30 days has passed after publication (S850), the article code restriction setup on the collected article is lifted in the restricted article database 204 to perform the article code restriction lifting (S851). By this, the collected article becomes disposable.

The disposal registration step S881 is initiated upon a disposal registration request for the article code from the collected terminal 2 following the disposal of the article. Also, the terminal code of a new owner is matched with the article code and registered in the registration history database 201 under the action code of disposal registration. To this end, the transfer registration step (FIG. 11) can be used instead.

In the article restriction lifting step (S871), when the article is collected (S840, S870) by the person who neglected it before the prescription period of collection S830 or the prescription period of disposal S850 expires, the article code restriction setup is lifted in the restriction article database 204 to perform the article code restriction lifting (S841, S871).

Next, the cancellation of neglected article collection report (S842, S890) is recorded in the collection database 210, and then the procedure is finished. To this end, the collection registration record may be deleted, or may be simply displayed in a cancellation flag, or the time of disposal may be recorded as illustrated.

Prior to the article collection (S840, S870) or the disposal (S880), if the ownership registration is done in the registration history database 201 by the neglected terminal 1 of the person who neglected it, that is, an article code overlap occurs in the article database 202 (S860), it is preferable to further provide a notification step S861 for notifying the neglected terminal 1, which is registered, of the collected terminal 2. Alternatively, contrariwise, the registered terminal may be notified to the collected terminal 2. By this, the collection of the article can be facilitated.

Prior to the article restriction setup step S824, if the article code is registered in ownership, that is, an article code overlap occurs (S820), it is preferable to further provide a message transmission step S821 for transmitting a message for giving a warning against collection to the registered terminal 1 for the article.

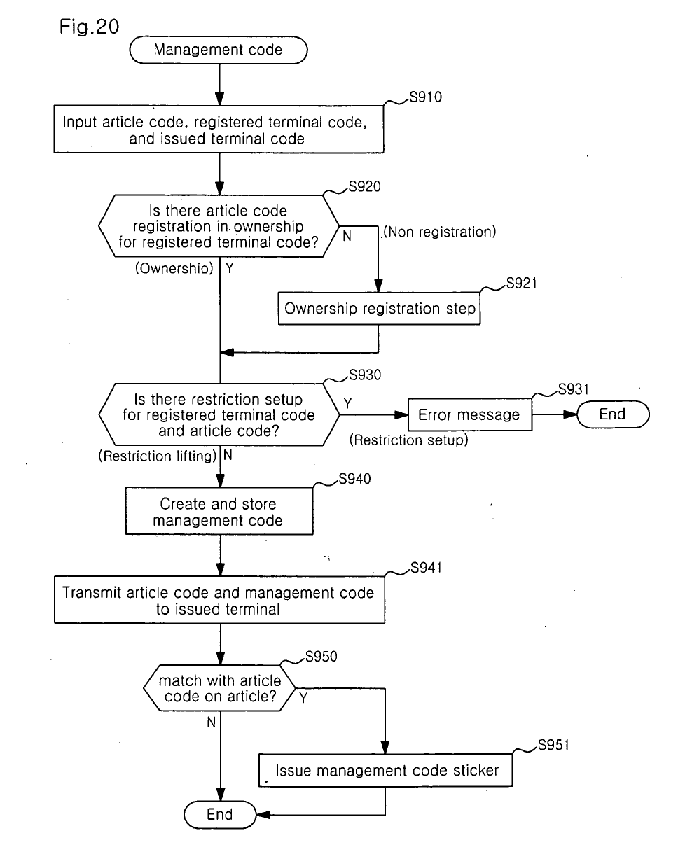

FIG. 20 is a flowchart showing the process of the management code issuing step.

To perform the management and processing step, a management code issuing step is provided in which a unique management code of the article corresponding to the article code is issued. For example, while a vehicle identify number represents an article code, the number of a license plate represents a management code.

Preferably, the management code issuing step includes a restriction setup confirmation step S930, a management code creation step S940, a management code transmission step S941, and a management code outputting step S951.

The restriction setup confirmation step S930 is initiated upon a management code issuing request S910 from the registered terminal 1 of the registrant to designate an issued terminal 2 for the article code. Preferably, the registered terminal code is automatically extracted and input via connection with the server 10 according to the well-known art. If ownership registration of the registered terminal code has not been performed yet in the registration history database 201, (S920), the ownership registration step S921 (i.e., S100) can be performed.

Next, it is checked whether there is article code restriction sep up on the ownership-registered article code by using the restricted article database 204 and the restricted terminal database 205, and whether there is terminal code restriction set up on the registered terminal code (S930). If there is restriction setup, an error message is output (S931), and the process is finished.

The management code creation step S940 is a step in which, if there is no restriction setup, a management code is created corresponding to the article code by a predetermined method. For example, a management code, a license plate number, is created based on a vehicle identify number.

To store (S940) the article code, the registered terminal code, and the issued terminal code, a management code database is preferably provided, and the structure thereof is as follows.

TABLE 16

| Time | Article code | Management code | Issued terminal code |
|---|---|---|---|
| Time 10 | A | A1 | B |

Herein, the management code, for example, afs39d1, is created in association with the article code by a predetermined method by an issuing organization. For convenience, the management may be abbreviated as A1, A2, etc, for example.

Moreover, an issuer database is preferably provided for the management of the issued terminal code, and the structure thereof is as follows.

TABLE 17

| Time | Government office | Person-in-charge | Issued terminal code |
|---|---|---|---|
| Time 10 | Yangcheon | Miran | B |

The management code database and the issuer database may be included in the code management database 211.

The management code transmission step S941 is a step of transmitting the management code to the issued terminal 2 along with the article code. The issued terminal 2 needs to be prevented from piracy or transformed applications by permitting only temporary storage rather than permanent storage.

In the management code output step S951; when the issuer confirms that the article code for the article is matched with the article code transmitted to the issued terminal 2, and inputs a confirmation signal (S950), the issued terminal 2 outputs (S951) the management code, for example, in the form of a sticker and issued it. The output management code may be attached to the article, and utilized as a mark that proves the article as registered in ownership.

For the article with the management code attached thereto, there is preferably provided a management code inquiry step for inquiring as to whether there is article code restriction set up on the article code corresponding to the management code.

Preferably, the management code inquiry step includes a restriction setup confirmation step, a first message transmission step, a registered terminal code input step, a second message transmission step, and a third message transmission step.

The restriction setup confirmation step is initiated upon a management code inquiry request from the inquiry terminal 2 of the inquirer. Preferably, the inquiry terminal code is automatically extracted and input via connection with the server 10 according to the well-known art. Then, the article code corresponding to the management code is searched in the management code database. If not found, this means that there is no management code issued. Thus, it can be determined that the management code is fake. If found, this shows that the issued code is at least valid. Whether there is article code restriction setup on the article code is checked in the restricted article database 204.

In the first message transmission step, if no restriction is set up on the article code, this means that the article is a normal article, and hence a first message, for example, ‘transaction available’ is transmitted along with the article code to the inquiry terminal 2.

In the registered terminal code input step, although the article is basically restricted if there is any restriction on the article code, the restriction may have been lifted from a particular confirmed terminal. Thus, a registered terminal code for the article code corresponding to the management code is input from the inquiry terminal 2.

In the second message transmission step, if the registered terminal code is a confirmed terminal code recognized as having the restriction lifted from the article code, a second message, for example, a message ‘genuine article’, is transmitted along with the article code to the inquiry terminal 2.

In the third message transmission step, if the registered terminal code is not a confirmed terminal code recognized as having the restriction lifted from the article code, a third message, for example, a message ‘overlapping article’ is transmitted to the inquiry terminal 2.

The article code transmitted along with the first, second, and third messages can be utilized for comparison with the article code of an article. To save an article inquiry record by the management code, a separate management code inquiry database is preferably provided, and the structure thereof may be almost the same as the article inquiry database 206.

Preferably, an inquiry notification step is further provided in which the registered terminal 1 for the article code of the article is notified of an article inquiry for the management code made by the inquiry terminal 2. Especially, if the registered terminal 1 already has performed loss/theft registration, it is very likely that the article to be inquired about is a lost or stolen article. Thus, it is preferable to refer to the loss article database 208, as well as to the article database 208, in order to search for the registered terminal 1.

The present invention is applicable to the industries of registration management, transfer registration, inquiry agency, lost or stolen article management, found article acquisition and management, neglected article collection, and management code issuing and attachment, which allows management of one's property, such as movable property, real estate, and pets, and offers convenience.

As described above, the embodiments of the present invention will be described with appropriately referring to drawings. However, the present invention should not be construed by limiting to these embodiments, and various changes, modifications, and improvements may be made on the basis of knowledge of a person of ordinary skill as long as they do not deviate from the range of the present invention.

### DRAWINGS

### [FIG. 1]

10: Server
100: Controller
110: Registration means
120: setup means
130: Post-processing means
132: Transfer handling means
134: Inquiry processing means
136: Lost article handling means
138: Found article handling means
140: Management means
200: Storage means
201: Registration history DB
202: Article DB
203: Terminal DB
204: Restricted article DB
205: Restricted terminal DB
206: Article inquiry DB
207: Terminal inquiry DB
208: Lost article DB
209: Found article DB
[symbol] : Police
210: Collected article DB
211: Code management DB
[symbol] : Police communication company
[symbol] : Manufacturer/Government office
300: Communication means

### [FIG. 2]

[symbol] : Menu
[symbol] : Original Registration [symbol] : First Person Registration
[symbol] : Seller Registration
[symbol] : Inquiry [symbol] : Article [symbol] : Terminal
[symbol] : Transfer Registration [symbol] : Gratuitous transfer
[symbol] : Onerous transfer
[symbol] : Direct payment [symbol] : Secure payment
[symbol] : Lost and Stolen
[symbol] : Found
[symbol] : Database
[symbol] : Registration history DB [symbol] : Restricted article DB
[symbol] : Restricted terminal DB [symbol] : Borrowed-name phone
[symbol] : Code management DB
[symbol] : Article inquiry DB [symbol] DB: Restricted article DB
[symbol] : Terminal inquiry DB [symbol] DB: Restricted terminal DB
[symbol] : Registration history DB [symbol] DB: Restricted article DB
[symbol] : Restricted terminal DB
[symbol] : borrowed-name account
[symbol] : Lost article DB [symbol] : Found article DB

### [FIG. 3]

AA . . . Start
S100 . . . Register ownership of an article code as a terminal code
S199 . . . Set up restrictions?
S200 . . . Set up restrictions on the article code and/or the terminal code
S299 . . . Lift the restrictions?
S300 . . . Lift restrictions on the article code and/or the terminal code
S399 . . . Process the article code/terminal code?
S400 . . . Manage and process the article code and the terminal code according to the restriction setup
BB . . . End

### [FIG. 4]

[symbol] : Ownership registration
S110: Input person-in-charge terminal code, registered terminal code, and article code
S120: Invalid article handling process
S130: Register registered terminal code matched with article code, while registering person-in-charge terminal code
S140: Terminal registration process for registered terminal code and person-in-charge code
S150: Article registration process for article code
End

### [FIG. 5]

[symbol] : Invalid article handling
S121: Article code valid?
N (Invalid article) Y (Valid article) S122: Error message End

### [FIG. 6]

[symbol] : Terminal registration
S141: Terminal code overlap?
N (No) (New)
Y (Normal) S142: Valid? N (Mistake)
S143: New terminal code registration S144: Error message Y (Yes) (Existing)
End

### [FIG. 7]

[symbol] : Article registration
S151: Article code overlap?
N (No) (New)
Y (Yes) (Existing)
S152: New article code registration
End

### [FIG. 8]

[symbol] : Restriction setup
S210: Article code overlap?
Y (Overlap) (Existing) S220: Article code restriction setup N (Normal) (New) S230: Restriction setup on the terminal code meet?
S240: Terminal code restriction setup
End

### [FIG. 9]

[symbol] : Terminal restriction lifting
S310: Any other reasons for restriction exist?
Y (Single restriction) N (There is other restriction) [symbol] : Loss/theft S320: Why overlap? [symbol] Simple mistake
S330: Number of registration setups for terminal code exceeds preset reference value?
N (Simple overlap registration) Y (Critical registration)
S321: Registered terminal as loss/theft?
S322: Registered terminal as genuine?
S323: Is there alternative register?
S340: Credit certification?
S341: Lift credit certified terminal restriction
S350: Other person-in-charge terminal prove?
S351: Lift proven terminal restriction
S352: Setup other person-in-charge terminal restriction
End

### [FIG. 10]

[symbol] : Article restriction lifting
[symbol] : Loss/theft S360: Why overlap? [symbol] : Simple mistake [symbol] : Fake
S370: Loss/theft article collect? S380: Genuine article verification?
S390: Is there alternative register?
S371: Lift article code restriction S381: Lift article code restriction only for confirmed terminal
S391: Lift article code restriction
End

### [FIG. 11]

[symbol] : Transfer registration
S410: Input current registered terminal code, new registered terminal code, and article code

S420: Is there article code registration in ownership for current registered terminal code?
N (Non registration) Y (Ownership) S421: Ownership registration step
S430: Is there article code restriction setup for current registered terminal code?
Y (Restriction setup) N (Restriction lifting) S431: Error message
S440: Terminal registration step for new registered terminal code
S450: Message indicating that there is no restriction for new registered terminal code
S460: Onerous transfer? Y (Onerous) N (Gratuitous)
S470: Secure payment? Y (Secure payment) N (Direct payment)
S471: Perform direct payment process S472: Perform secure payment process
S480: Register new registered terminal code matched with article code as registered terminal code, and current registered terminal code as person-in-charge terminal code
End

### [FIG. 12]

[symbol] : Terminal inquiry
S510: Input inquiry terminal code and registered terminal code
S511: Store inquiry terminal code and registered terminal code
S520: Registered terminal code restriction setup?
N (Normal phone) Y (Restricted phone)
S521: Error message S522: Restriction message
End

### [FIG. 13]

[symbol] : Article inquiry
S530: Input inquiry terminal code and article code
S531: Validity confirmation step
S540: article code restriction setup?
S541: Input registered terminal code
S542: Store registered terminal code
S550: Confirmed terminal?
Y (Allowed article) N (Restricted article)
S551, 552: Error message S553: Restriction message
S560: Is there loss/theft registration?
S561: Notify article inquiry to registered terminal
End

### [FIG. 14]

[symbol] : Loss/theft registration
S610: Input article code and lost terminal code
S611: Validity confirmation step
S612: Is there ownership registration of the article code for lost terminal code
N (Non registration) Y (Ownership) S621: Ownership registration step
S630: Article code restriction setup
End

### [FIG. 15]

[symbol] : Completion of loss/theft registration
S640: Is there registration for finding of lost article/article code inquiry
Y (Concerned article)
S641: Notify lost terminal of found/inquiry terminal
S650: Article collected?
S651: Lift article code restriction
S652: Cancellation of loss/theft registration
End

### [FIG. 16]

[symbol] : Lost article is found
S710: Input article code, found terminal code
S711: Validity confirmation step
S712: Store article code, found terminal code
S720: Article code overlap?
N (New) Y (Existing)
S721: Terminal registration step for found terminal code
S722: Article registration step for article code
S730: Lift article code restriction
End

### [FIG. 17]

[symbol] : completion of lost article registration
S750: Article code overlap?
S751: Notify restricted terminal of found terminal
S740: Preset acquisition period expires?
S760: Article collected?
S741: Register found terminal code matched with article code to registered terminal code
S770: Lift article code restriction
S780: Cancellation of loss/theft registration
End

### [FIG. 18]

[symbol] : collect neglected article
S810: Input article code and collected terminal code
S811: Validity confirmation step
S812: Store article code and collected terminal code
S820: Article code overlap?
N (New) Y (Existing)
S821: Transmit message for giving a warning against collection to the registered terminal
S822: Terminal registration step for collected terminal code
S823: Article registration step for article code
S824: Lift article code restriction
S830: Preset acquisition period expires?
S840: Article collected?
S831: Collect article
S841: Lift article code restriction
S842: Lift Neglected article collect registration
End

### [FIG. 19]

[symbol] : completion of neglected article acquisition registration
S860: Article code overlap?
S861: Notify found terminal to restricted terminal
S850: Preset acquisition period expire?
S870: Article collected?
S851, 871: Lift article code restriction
S880: Disposal?
S881: Transfer registration step
S842: Lift Neglected article collect registration
End

### [FIG. 20]

[symbol] : Management code
S910: Input article code, registered terminal code, and issued terminal code
S920: Is there article code registration in ownership for registered terminal code?
N (Non registration) Y (Ownership) S921: Ownership registration step
S930: Is there article code restriction setup for registered terminal code?
Y (Restriction setup) N (Restriction lifting) S431: Error message End
S940: Create and Store management code
S941: Transmit article code and management code to issued terminal
S950: Article match with article code?
S951: issue management code sticker
End

1. An article management method which uses a system including a server that stores not only an intrinsic article code for an article but also an intrinsic terminal code for an article owner's terminal, and a terminal that connects to the server based on the terminal code, the method comprising:
an ownership registration step of registering the terminal code to the server as a registration terminal code by matching the terminal code with the article code, upon request from the terminal for registration of the article code;
a restriction setup step of setting up restrictions on at least one of the article code and the terminal code when preset conditions for the restriction setup are met;
a restriction lifting step of lifting the restrictions on at least one of the article code and the terminal code when preset conditions for the restriction lifting are met; and
a management and processing step of enabling management and processing depending on whether the restriction is set up for at least one of the article code and the terminal code when preset management and processing are performed for at least one of the article code and the terminal code, upon request from the terminal for management and processing.

2. The method of claim 1, preferably the ownership registration step is initiated upon an ownership registration request from a person-in-charge terminal, a terminal of the person in charge of the article,
the request for ownership registration is a request for issuing ownership registration by matching the article code with the terminal code of the registered terminal, and
according to the ownership registration request, the terminal code for the registered terminal is registered to the server as a registered terminal code by matching the terminal code with the article code, and the terminal code of the person-in-charge terminal is also registered to the server as a person-in-charge terminal code.

3. The method of claim 1, preferably, in the ownership registration step, if the terminal code has not been registered, it is determined whether the terminal code is valid, and
new terminal code registration is performed on the terminal code in a case that the terminal code is valid.

4. The method of claim 1, wherein, in the ownership registration step, it is determined whether the article code is valid, and
if the article code is valid and unregistered, new terminal code registration is performed on the terminal code.

5. The method of claim 1, wherein, in the restriction setup step, if the article code desired to be registered in ownership overlaps a previously registered article code, it is determined whether preset conditions for the restriction setup on the terminal code are met, and
if the preset conditions for the restriction setup on the terminal code are met, a terminal code restriction setup is performed on the terminal code registered in ownership.

6. The method of claim 1, wherein, in the restriction setup step, if the article code desired to be registered in ownership overlaps a previously registered article code, an article code restriction setup is performed on the overlapping article code.

7. The method of claim 5, wherein, in the restriction lifting step, if there is no other reason for the restriction on the terminal code associated with the overlapping article code, the following is carried out:
(1) If the article code overlap is caused by loss registration or theft registration, terminal code registration lifting is performed on the terminal code for the terminal registered as lost or stolen;
(2) If the article code overlap is caused by ownership registration of a false article, terminal code registration lifting is performed on the terminal code for the confirmed terminal, i.e., the terminal proven to be and registered as genuine; and
(3) If the article code overlap is caused by multiple ownership registrations only a mistake, terminal code restriction lifting is performed on the terminal codes for all the terminals with registered ownership associated with alternative declaration that only one of the multiple ownership registrations is valid.

8. The method of claim 5, wherein, in the restriction lifting step, if there exists any other reason for the restriction on the terminal code associated with the overlapping article code, and the number of registration setups for the terminal code exceeds a preset reference value, the following is carried out:
(1) Terminal code registration lifting is performed on the terminal code for the terminal that has registered credit certification, and
(2) Terminal code restriction lifting is performed on the terminal code for the terminal for which it has been proven that the person-in-charge terminal is responsible for the article code overlap, and terminal code restriction setup is performed for the terminal code of the person-in-charge terminal.

9. The method of claim 6, wherein, in the restriction lifting step,
(1) If the article code overlap is caused by loss registration or theft registration, terminal code registration lifting is performed when the article registered as lost or stolen is collected;
(2) If the article code overlap is caused by ownership registration of a false article, terminal code registration lifting is performed on the terminal code for the confirmed terminal, i.e., the terminal proven to be and registered as genuine; and
(3) If the article code overlap is caused by multiple ownership registrations only a mistake, terminal code restriction lifting is performed as far as alternative declaration is made that only one of the multiple ownership registrations is valid.

10. The method of claim 1, wherein, to perform the management and processing step, a transfer registration step is provided in which the article code registered in ownership corresponding to the current registered terminal code is changed to correspond to a new registered terminal code and registered,
the transfer registration step comprising:
a restriction setup confirmation step in which it is confirmed that no restriction is set up on the article code and no restriction on the terminal code is set up on the current registered terminal code upon a transfer registration request from the current registered terminal that requests to change the article code to an article code for the new registered terminal and register the new article code;
a message transmission step in which, if there is no restriction setup, a message indicating that there is no restriction on transfer registration is transmitted to the terminal of the new registered terminal code;
a transfer registration execution confirmation step in which a transfer registration execution request is received from the current registered terminal code and the new registered terminal code; and
a change registration step in which the new registered terminal code is matched with the article code and registered, and the current registered terminal code, is registered as a person-in-charge terminal code.

11. The method of claim 10, wherein, if the transfer registration is onerous transfer registration, money is deposited after the transfer registration execution confirmation step, and then transferred upon receipt of a money transfer execution request from the current registered terminal code and the new registered terminal code.

12. The method of claim 1, wherein, to perform the management and processing step, a terminal inquiry step is provided in which an inquiry is made as to whether restriction is set up on the terminal code registered in ownership,
the terminal inquiry step comprising:
a restriction setup confirmation step in which it is checked whether restriction is setup on the registered terminal code upon a terminal inquiry request from the inquiry terminal of the inquirer; and
a message transmission step in which, if no restriction is set up on the registered terminal code, a first message is transmitted to the inquiry terminal, and if restriction is setup on the registered terminal code, a second message is transmitted to the inquiry terminal.

13. The method of claim 1, wherein, to perform the management and processing step, an article inquiry step is provided in which an inquiry is made as to whether restriction is set up on the article code registered in ownership,
the article inquiry step comprising:
a restriction setup confirmation step in which it is checked whether restriction is set up on the article code upon an article inquiry request from the inquiry terminal of the inquirer;
a first message transmission step in which, if no restriction is set up on the article code, a first message is transmitted to the inquiry terminal;
a registered terminal code input step in which, if there is any restriction on the article code, a registered terminal code corresponding to the article code is input from the inquiry terminal;
a second message transmission step in which, if the registered terminal code is a confirmed terminal code recognized as having the restriction lifted from the article code, a second message is transmitted to the inquiry terminal; and
a third message transmission step in which, if the registered terminal code is not a confirmed terminal code recognized as having the restriction lifted from the article code, a third message is transmitted to the inquiry terminal.

14. The method of claim 13, further comprising an inquiry notification step in which the registered terminal is notified of an article inquiry made by the inquiry terminal.

15. The method of claim 1, wherein, to perform the management and processing step, a loss registration step is provided in which loss or theft of an article corresponding to the article code is handled,
the loss registration step comprising:
an article restriction setup step in which article code restoration is set up on the article code upon a loss registration request for the article code from the lost terminal of the person who lost it; and
an article restriction lifting step in which, when the article is collected by the person who lost it, the article code restriction is lifted.

16. The method of claim 15, further comprising a notification step in which, prior to the collection of the article, if the lost article registration for the article code is done by the lost terminal of the finder, or the inquiry registration for the article code is done by the inquiry terminal of the inquirer, notifying the lost terminal is notified of the found terminal or inquiry terminal.

17. The method of claim 1, wherein, to perform the management and processing step, a found article registration step is provided in which finding of the article corresponding to the article code is handled,
the found article registration step comprising:
an article restriction setup step in which article code restriction is set up on the article code upon a found article registration request for the article code from the found terminal of the finder;
an acquisition registration step in which, when a preset acquisition period expires, the found terminal code is matched with the article code and registered, and the article code restriction is lifted; and
an article restriction lifting step in which, when the article is collected by the person who lost it before the expiration of the prescription date of acquisition, the article code restriction is lifted.

18. The method of claim 17, further comprising a notification step in which, prior to the acquisition registration step, if the ownership registration is done in the registration history database by the lost terminal of the person who lost it, the lost terminal is notified of the found terminal.

19. The method of claim 1, wherein, to perform the management and processing step, a collection registration step is provided in which collection of the article corresponding to the article code is handled,
the collection registration step comprising:
an article restriction setup step in which article code restriction is set up on the article code upon a collection registration request for the article code from the collected terminal of the collector;
a collection step in which, when a preset prescription period of collection expires, the article is collected;
a disposal restriction lifting step in which, when a present prescription period of disposal expires, the article code restriction setup on the collected article is lifted;
a disposal registration step in which the terminal code of a new owner is matched with the article code and registered upon a disposal registration request for the article code from the collected terminal following the disposal of the article; and
an article restriction setup lifting step in which, when the article is collected by the person who neglected it before the prescription period of collection or the prescription period of disposal expires.

20. The method of claim 19, further comprising a notification step in which, prior to the article collection or the disposal, if the ownership registration is done by the neglected terminal of the person who neglected it, the neglected terminal is notified of the collected terminal.

21. The method of claim 19, further comprising a message transmission step in which, prior to the article restriction setup step, if the article code is registered in ownership, a message for giving a warning against collection is transmitted to the registered terminal for the article.

22. The method of claim 1, wherein, to perform the management and processing step, a management code issuing step is provided in which a unique management code of the article corresponding to the article code is issued,
the management code issuing step comprising:
a restriction setup confirmation step in which it is checked whether there is article code restriction sep up on the ownership-registered article code, and whether there is article code restriction set up on the registered terminal code;
a management code creation step in which, if there is no restriction setup, a management code is created corresponding to the article code by a predetermined method;
a management code transmission step of transmitting the management code to the issued terminal along with the article code; and
a management code output step in which, if the article code for the article is matched with the article code transmitted to the issued terminal, the issued terminal outputs the management code.

23. The method of claim 22, wherein there is provided a management code inquiry step for inquiring as to whether there is article code restriction set up on the article code corresponding to the management code,
the management code inquiry step comprising:
a restriction setup confirmation step in which article code restriction is set up on the article code corresponding to the management code upon a management code inquiry request from the inquiry terminal of the inquirer;
a first message transmission step in which, if no restriction is set up on the article code, a first message is transmitted along with the article code to the inquiry terminal;
a registered terminal code input step in which, if restriction is set up on the article code, a registered terminal code for the article code corresponding to the management code is input from the inquiry terminal;
a second message transmission step in which, if the registered terminal code is a confirmed terminal code recognized as having the restriction lifted from the article code, a second message is transmitted along with the article code to the inquiry terminal; and
a third message transmission step in which, if the registered terminal code is not a confirmed terminal code recognized as having the restriction lifted from the article code, a third message is transmitted to the inquiry terminal.

24. The method of claim 23, further comprising an inquiry notification step in which the registered terminal is notified of an article inquiry made by the inquiry terminal.
